(19) United States
(12) Patent Application Publication
(10) Pub. No.: US 2011/0112843 A1
(43) Pub. Date: May 12, 2011

(54) SIGNAL ANALYZING DEVICE, SIGNAL CONTROL DEVICE, AND METHOD AND PROGRAM THEREFOR

(75) Inventors: Osamu Shimada, Tokyo (JP); Toshiyuki Nomura, Tokyo (JP)

(73) Assignee: NEC Corporation, Minato-ku, Tokyo (JP)

(21) Appl. No.: 13/003,522

(22) PCT Filed: Jul. 9, 2009
(86) PCT No.: PCT/JP2009/062522

§ 371 Date: Jan. 10, 2011

(30) Foreign Application Priority Data
Jul. 11, 2008 (JP) 2008-181242

(51) Int. Cl. G10L 19/00

(52) U.S. Cl. 704/500; 704/E19.001

(57) ABSTRACT

Provided is a signal analyzing device comprising a separate information calculating unit for generating separate information to separate an input signal mixed with a sound source signal, into the sound source signal. The signal-analyzing device is characterized by sending out the input signal and the separate information.

### TECHNICAL FIELD

The present invention relates to a signal analysis apparatus, a signal control apparatus, and a method and a program therefor.

### BACKGROUND ART

As a system for transmitting a multichannel input signal having one sound source signal or a plurality of sound source signals mixed therein, and controlling a decoded signal in a receiving side, there exists the technology shown in FIG. 17. The related arts will be explained by making a reference to FIG. 17. In a system of FIG. 17, an encoding unit 900 generates encoded multichannel signals by encoding the multichannel input signals. As a method of encoding the multichannel signals, the AAC technique disclosed in Non-patent literature 1 is known. The encoding unit 900 outputs the encoded multichannel signal as a transmission signal. The transmission signal is supplied to a decoding unit 910 via a transmission path.

The decoding unit 910 decodes the received transmission signal into a multichannel decoded signal. And, the decoding unit 910 supplies the multichannel decoded signal to a signal resynthesis unit 920. When the signal is encoded with the AAC technique, the decoding unit 910 generates the multichannel decoded signal by decoding the information encoded with the AAC technique. The signal resynthesis unit 920, upon receipt of the multichannel decoded signal, and output signal information, resynthesizes the multichannel output signal by localizing the multichannel decoded signal in a desired position based upon the output signal information. And, the signal resynthesis unit 920 outputs a multichannel output signal. As a method of resynthesizing the multichannel output signal, the enhanced matrix mode disclosed in Non-patent literature 2 can be employed. Herein, the so-called output signal information is information representing a relation between the multichannel decoded signal and the multichannel output signal.

### CITATION LIST

### Non-Patent Literature

NON-PTL 1: ISO/IEC 14496-3: 2005 Part 3 Audio
NON-PTL 2: ISO/IEC 23003-1: 2007 Part 1 MPEG Surround

### SUMMARY OF INVENTION

### Technical Problem

The foregoing related prior arts, however, cause a problem that the sound source signals constituting the multichannel input signal cannot be controlled independently. The reason is that the foregoing related prior arts control the multichannel input signal having the sound source signals mixed therein, and do not take a control for each sound source signal. That is, the foregoing related prior arts are not capable of taking such a control of changing the localization of a specific sound source signal to be included in the multichannel input signal, and suppressing or emphasizing only a specific sound source signal to be included in the multichannel input signal.

Thereupon, the present invention has been accomplished in consideration of the above-mentioned problems, and an object thereof is to provide a signal analysis apparatus and a signal control apparatus capable of independently controlling one sound source signal or plural ones constituting the multichannel input signal, and a method and a program therefor.

### Solution to Problem

The present invention for solving the above-mentioned problems is a signal analysis apparatus comprising a separation information calculation unit for generating separation information for separating an input signal having sound source signals mixed therein into said sound source signals, said signal analysis apparatus sending said input signal and said separation information.

The present invention for solving the above-mentioned problems is a signal analysis apparatus, comprising: a resynthesis information calculation unit for generating separation information for separating an input signal having sound source signals mixed therein into said sound source signals, and resynthesis information representing a relation between said input signal and said sound source signal; and a signal separation unit for generating separated signal by separating said input signal into said sound source signals based upon said separation information, said signal analysis apparatus sending said separated signal and said resynthesis information.

The present invention for solving the above-mentioned problems is a signal analysis apparatus, comprising: a separation information calculation unit for generating separation information for separating an input signal having sound source signals mixed therein into said sound source signals; a signal separation unit for generating separated signal by separating said input signal into said sound source signals based upon said separation information; and an encoding unit for encoding said separated signal.

The present invention for solving the above-mentioned problems is a signal control apparatus for receiving a mixed signal having sound source signals mixed therein, separation information for separating said mixed signal into said sound source signals, and output signal information for controlling a specific sound source signal, comprising: a separation/resynthesis information generation unit for generating separation/resynthesis information for controlling said sound source signals from said output signal information and said separation information; and a signal resynthesis unit for modifying said mixed signal based upon said separation/resynthesis information.

The present invention for solving the above-mentioned problems is a signal control apparatus for receiving a down-mixed signal having a mixed signal down-mixed therein, said mixed signal having sound source signals mixed therein, analysis information representing a relation between said down-mixed signal and said mixed signal, separation information for separating said mixed signal into said sound source signals, and output signal information for controlling a specific sound source signal, comprising: a separation/resynthesis information generation unit for generating modified separation/resynthesis information for controlling said sound source signals from said output signal information, said analysis information, and said separation information; and a signal resynthesis unit for modifying said down-mixed signal based upon said modified separation/resynthesis information.

The present invention for solving the above-mentioned problems is a signal control apparatus for receiving a separated signal obtained by separating a mixed signal having sound source signals mixed therein, resynthesis information representing a relation between said mixed signal and said separated signal, and output signal information for controlling a specific sound source signal, comprising: a resynthesis information integration unit for generating integrated resynthesis information for controlling said sound source signals from said output signal information and said resynthesis information; and a signal resynthesis unit for modifying said separated signal based upon said modified separation/resynthesis information.

The present invention for solving the above-mentioned problems is a signal control apparatus for receiving a down-mixed signal having a separated signal down-mixed therein, said separated signal obtained by separating a mixed signal having sound source signals mixed therein, analysis information representing a relation between said down-mixed signal and said separated signal, resynthesis information representing a relation between said mixed signal and said separated signal, and output signal information for controlling a specific sound source signal, comprising: a resynthesis information modification unit for generating modified resynthesis information for controlling said sound source signals from said output signal information, said analysis information, and said resynthesis information; and a signal resynthesis unit for modifying said down-mixed signal based upon said modified resynthesis information.

The present invention for solving the above-mentioned problems is a signal control apparatus for receiving a separated signal obtained by separating a mixed signal having sound source signals mixed therein, and output signal information for controlling a specific sound source signal, comprising a signal resynthesis unit for modifying said separated signal based upon said output signal information.

The present invention for solving the above-mentioned problems is a signal control apparatus for receiving a down-mixed signal having a separated signal down-mixed therein, said separated signal obtained by separating a mixed signal having sound source signals mixed therein, analysis information representing a relation between said down-mixed signal and said separated signal, and output signal information for controlling a specific sound source signal, comprising: a resynthesis information modification unit for generating modified resynthesis information for controlling said sound source signals from said output signal information and said analysis information; and a signal resynthesis unit for modifying said down-mixed signal based upon said modified resynthesis information.

The present invention for solving the above-mentioned problems is a signal control apparatus for receiving a mixed signal having sound source signals mixed therein, and output signal information for controlling a specific sound source signal, comprising: a separation information calculation unit for generating separation information for separating said mixed signal into said sound source signals; a separation/resynthesis information generation unit for generating separation/resynthesis information for controlling said sound source signals from said output signal information and said separation information; and a signal resynthesis unit for modifying said mixed signal based upon said separation/resynthesis information.

The present invention for solving the above-mentioned problems is a signal analysis method, comprising: generating separation information for separating an input signal having sound source signals mixed therein into said sound source signals; and sending said input signal and said separation information.

The present invention for solving the above-mentioned problems is a signal analysis method, comprising: generating separation information for separating an input signal having sound source signals mixed therein into said sound source signals, and resynthesis information representing a relation between said input signal and said sound source signal; and generating a separated signal by separating said input signal into said sound source signals based upon said separation information; and sending said separated signal and said resynthesis information.

The present invention for solving the above-mentioned problems is a signal analysis method, comprising: generating separation information for separating an input signal having sound source signals mixed therein into said sound source signals; generating a separated signal by separating said input signal into said sound source signals based upon said separation information; and encoding said separated signal.

The present invention for solving the above-mentioned problems is a signal control method comprising: receiving a mixed signal having sound source signals mixed therein, separation information for separating said mixed signal into said sound source signals, and output signal information for controlling a specific sound source signal; generating separation/resynthesis information for controlling said sound source signals from said output signal information and said separation information; and modifying said mixed signal based upon said separation/resynthesis information.

The present invention for solving the above-mentioned problems is a signal control method, comprising: receiving a down-mixed signal having a mixed signal down-mixed therein, said mixed signal having sound source signals mixed therein, analysis information representing a relation between said down-mixed signal and said mixed signal, separation information for separating said mixed signal into said sound source signals, and output signal information for controlling a specific sound source signal; generating modified separation/resynthesis information for controlling said sound source signals from said output signal information, said analysis information and said separation information; and modifying said down-mixed signal based upon said modified separation/resynthesis information.

The present invention for solving the above-mentioned problems is a signal control method, comprising: receiving a separated signal obtained by separating a mixed signal having sound source signals mixed therein, resynthesis information representing a relation between said mixed signal and said separated signal, and output signal information for controlling a specific sound source signal; generating integrated resynthesis information for controlling said sound source signals from said output signal information and said resynthesis information; and modifying said separated signal based upon said modified separation/resynthesis information.

The present invention for solving the above-mentioned problems is a signal control method, comprising receiving a down-mixed signal having a separated signal down-mixed therein, said separated signal obtained by separating a mixed signal having sound source signals mixed therein, analysis information representing a relation between said down-mixed signal and said separated signal, resynthesis information representing a relation between said mixed signal and said separated signal, and output signal information for controlling a specific sound source signal; generating modified resynthesis information for controlling said sound source signals from said output signal information, said analysis information, and said resynthesis information; and modifying said down-mixed signal based upon said modified resynthesis information.

The present invention for solving the above-mentioned problems is a signal control method, comprising: receiving a separated signal obtained by separating a mixed signal having sound source signals mixed therein, and output signal information for controlling a specific sound source signal; and modifying said separated signal based upon said output signal information.

The present invention for solving the above-mentioned problems is a signal control method, comprising: receiving a down-mixed signal having a separated signal down-mixed therein, said separated signal obtained by separating a mixed signal having sound source signals mixed therein, analysis information representing a relation between said down-mixed signal and said separated signal, and output signal information for controlling a specific sound source signal; generating modified resynthesis information for controlling said sound source signals from said output signal information and said analysis information; and modifying said down-mixed signal based upon said modified resynthesis information.

The present invention for solving the above-mentioned problems is a signal control method, comprising: receiving a mixed signal having sound source signals mixed therein, and output signal information for controlling a specific sound source signal; generating separation information for separating said mixed signal into said sound source signals; generating separation/resynthesis information for controlling said sound source signals from said output signal information and said separation information; and modifying said mixed signal based upon said separation/resynthesis information.

The present invention for solving the above-mentioned problems is a program for causing an information processing apparatus to execute a separation information calculation process of generating separation information for separating an input signal having sound source signals mixed therein into said sound source signals.

The present invention for solving the above-mentioned problems is a program for causing an information processing apparatus to execute: a resynthesis information calculation process of generating separation information for separating an input signal having sound source signals mixed therein into said sound source signals and resynthesis information representing a relation between said input signal and said sound source signal; and a signal separation process of generating a separated signal by separating said input signal into said sound source signals based upon said separation information.

The present invention for solving the above-mentioned problems is a program for causing an information processing apparatus to execute: a separation information calculation process of generating separation information for separating an input signal having sound source signals mixed therein into said sound source signals; a signal separation process of generating a separated signal by separating said input signal into said sound source signals based upon said separation information; and an encoding process of encoding said separated signal.

The present invention for solving the above-mentioned problems is a program for causing an information processing apparatus into which a mixed signal having sound source signals mixed therein, separation information for separating said mixed signal into said sound source signals, and output signal information for controlling a specific sound source signal are inputted to execute: a separation/resynthesis information generation process of generating separation/resynthesis information for controlling said sound source signals from said output signal information and said separation information; and a signal resynthesis process of modifying said mixed signal based upon said separation/resynthesis information.

The present invention for solving the above-mentioned problems is a program for causing an information processing apparatus into which a down-mixed signal having a mixed signal down-mixed therein, said mixed signal having sound source signals mixed therein, analysis information representing a relation between said down-mixed signal and said mixed signal, separation information for separating said mixed signal into said sound source signals, and output signal information for controlling a specific sound source signal are inputted to execute; a separation/resynthesis information generation process of generating modified separation/resynthesis information for controlling said sound source signals from said output signal information, said analysis information and said separation information; and a signal resynthesis process of modifying said down-mixed signal based upon said modified separation/resynthesis information.

The present invention for solving the above-mentioned problems is a program for causing an information processing apparatus into which a separated signal obtained by separating a mixed signal having sound source signals mixed therein, resynthesis information representing a relation between said mixed signal and said separated signal, and output signal information for controlling a specific sound source signal are inputted to execute: a resynthesis information integration process of generating integrated resynthesis information for controlling said sound source signals from said output signal information and said resynthesis information; and a signal resynthesis process of modifying said separated signal based upon said modified separation/resynthesis information.

The present invention for solving the above-mentioned problems is a program for causing an information processing apparatus into which a down-mixed signal having a separated signal down-mixed therein, said separated signal obtained by separating a mixed signal having sound source signals mixed therein, analysis information representing a relation between said down-mixed signal and said separated signal, resynthesis information representing a relation between said mixed signal and said separated signal, and output signal information for controlling a specific sound source signal are inputted to execute: a resynthesis information modification process of generating modified resynthesis information for controlling said sound source signals from said output signal information, said analysis information, and said resynthesis information; and a signal resynthesis process of modifying said down-mixed signal based upon said modified resynthesis information.

The present invention for solving the above-mentioned problems is a program for causing an information processing apparatus into which a separated signal obtained by separating a mixed signal having sound source signals mixed therein, and output signal information for controlling a specific sound source signal are inputted to execute a signal resynthesis process of modifying said separated signal based upon said output signal information.

The present invention for solving the above-mentioned problems is a program for causing an information processing apparatus into which a down-mixed signal having a separated signal down-mixed therein, said separated signal obtained by separating a mixed signal having sound source signals mixed therein, analysis information representing a relation between said down-mixed signal and said separated signal, and output signal information for controlling a specific sound source signal are inputted to execute: a resynthesis information modification process of generating modified resynthesis information for controlling said sound source signals from said output signal information and said analysis information; and a signal resynthesis process of modifying said down-mixed signal based upon said modified resynthesis information.

The present invention for solving the above-mentioned problems is a program for causing an information processing apparatus into which a mixed signal having sound source signals mixed therein, and output signal information for controlling a specific sound source signal are inputted to execute: a separation information calculation process of generating separation information for separating said mixed signal into said sound source signals; a separation/resynthesis information generation process of generating separation/resynthesis information for controlling said sound source signals from said output signal information and said separation information; and a signal resynthesis process of modifying said mixed signal based upon said separation/resynthesis information.

### ADVANTAGEOUS EFFECT OF INVENTION

The present invention makes it possible to independently controlling one sound source signal or plural ones constituting the multichannel input signal based upon the output signal information.

### BRIEF DESCRIPTION OF DRAWINGS

FIG. 1 is a block diagram illustrating a first embodiment of the present invention.

FIG. 2 shows a configuration example of a separation/resynthesis information generation unit 320.

FIG. 3 is a block diagram illustrating a second embodiment of the present invention.

FIG. 4 shows a configuration example of a low-bit rate encoding unit 400.

FIG. 5 shows a configuration example of a separation/resynthesis information generation unit 420.

FIG. 6 is a block diagram illustrating a third embodiment of the present invention.

FIG. 7 shows a first configuration example of a resynthesis information calculation unit 510.

FIG. 8 shows a second configuration example of the resynthesis information calculation unit 510.

FIG. 9 is a block diagram illustrating a fourth embodiment of the present invention.

FIG. 10 shows a configuration example of a resynthesis information modification unit 620.

FIG. 11 is a block diagram illustrating a fifth embodiment of the present invention.

FIG. 12 is a block diagram illustrating a sixth embodiment of the present invention.

FIG. 13 shows a configuration example of a low-bit rate encoding unit 210.

FIG. 14 is a block diagram illustrating a seventh embodiment of the present invention.

FIG. 15 is a block diagram illustrating an eighth embodiment of the present invention.

FIG. 16 is a block diagram illustrating a ninth embodiment of the present invention.

FIG. 17 is a block diagram illustrating the related arts of the present invention.

### DESCRIPTION OF EMBODIMENTS

Embodiments of the signal analysis control system of the present invention will be explained in details by making a reference to the accompanied drawings.

### First Embodiment

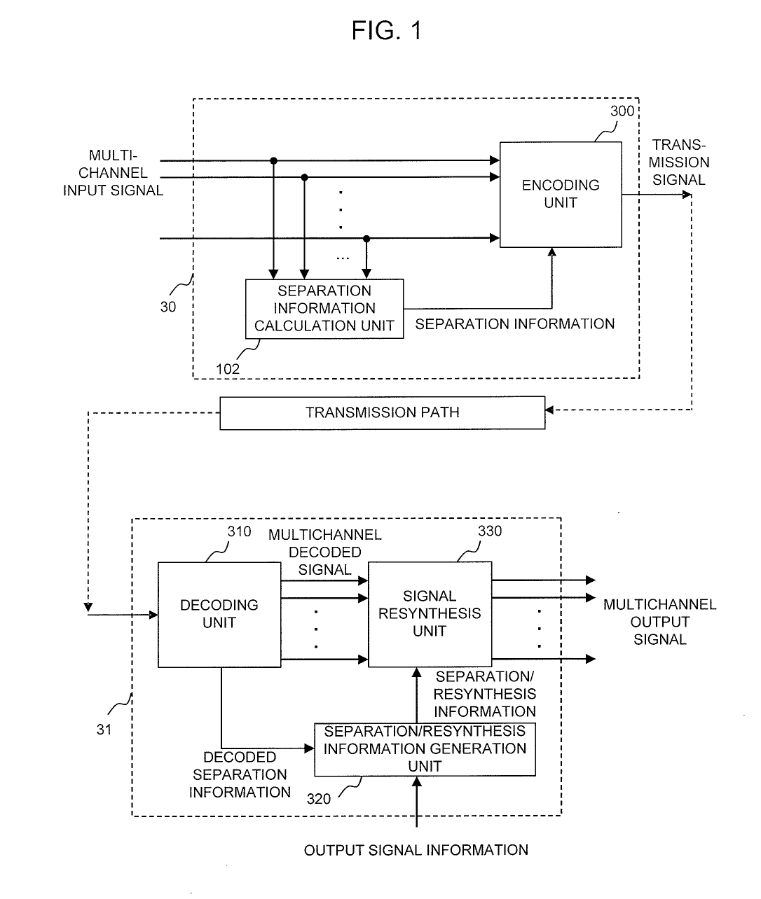

A first embodiment of the signal analysis control system of the present invention will be explained in details by making a reference to FIG. 1. The signal analysis control system of the present invention assumes a configuration in which a transmission unit 30 and a receiving unit 31 are connected via a transmission path. The transmission unit 30 receives a multichannel input signal having one or plural sound source signals mixed therein, and outputs a transmission signal. The transmission signal is inputted into the receiving unit 31 via the transmission path. The receiving unit 31 receives the transmission signal and the output signal information, and outputs a multichannel output signal. Further, the transmission unit, the transmission path, and the receiving unit could be a recording unit, a storage medium, and a reproduction unit, respectively.

Hereinafter, while the case of the multichannel input signal having a plurality of the sound source signals mixed therein is described in the explanation of the present invention, the present invention is also applicable to the case of the multichannel input signal having one sound source signal mixed therein.

When the multichannel input signal is collected, for example, by a plurality of microphones, information of installment positions and directivities of a plurality of microphone can be incorporated into the multichannel input signal. Further, when the multichannel input signal is a digital signal, information of sampling frequencies can be incorporated therein. These items of the information can be utilized when information for separating the multichannel input signal into the sound source signals, which is later described, is calculated.

The transmission unit 30 receives the multichannel input signal having a plurality of the sound source signals mixed therein, and outputs the transmission signal. The transmission unit 30 is configured of a separation information calculation unit 102 and an encoding unit 300. The multichannel input signal is inputted into the separation information calculation unit 102 and the encoding unit 300. The separation information calculation unit 102 generates the separation information for separating the multichannel input signal into a plurality of the sound source signals. And, the separation information calculation unit 102 outputs separation information to the encoding unit 300. The encoding unit 300 generates the transmission signal by encoding the multichannel input signal, and the separation information received from the separation information calculation unit 102. And, the encoding unit 300 outputs the transmission signal to the transmission path.

The receiving unit 31 receives the transmission signal and the output signal information, and outputs the multichannel output signal. The receiving unit 31 is configured of a decoding unit 310, a separation/resynthesis information generation unit 320, and a signal resynthesis unit 330. The transmission signal is inputted into the decoding unit 310. The output signal information is inputted into the separation/resynthesis information generation unit 320. At first, the decoding unit 310 decodes the received transmission signal into a multichannel decoded signal and decoding separation information. Continuously, the decoding unit 310 outputs the multichannel decoded signal and the decoding separation information to the signal resynthesis unit 330 and the separation/resynthesis information generation unit 320, respectively. The separation/resynthesis information generation unit 320 generates separation/resynthesis information by integrating the output signal information, and the decoding separation information received from the decoding unit 310. And, the separation/resynthesis information generation unit 320 outputs the separation/resynthesis information to the signal resynthesis unit 330. The signal resynthesis unit 330 resynthesizes the multichannel decoded signal by modifying the multichannel decoded signal received from the decoding unit 310 based upon the separation/resynthesis information received from the separation/resynthesis information generation unit 320. The signal resynthesis unit 330 outputs the multichannel output signal.

The output signal information is information for outputting a plurality of the sound source signals to be included in the multichannel input signal to a plurality of output channels. That is, the output signal information is information representing a relation between each sound source signal and the multichannel output signal for each frequency component. For example, the output signal information may include localization information of each sound source signal. The output signal information may include information for manipulating localization feeling by shading-off the sound image. Utilizing the output signal information makes it possible to control the signal outputted to each output channel for each sound source signal. Each sound source signal may be output from a specific one output channel (for example, a loudspeaker) in some cases, and may be distributed and outputted to a plurality of the output channels in some cases. For example, outputting a specific sound source signal only from a specific output channel makes it possible to clearly localize the sound source signal and to improve realistic sensation. Further, a specific sound source signal may be suppressed or emphasized.

The output signal information may be inputted based upon information that is obtained by a user from the outside. For example, as information being inputted from the outside, there exists personal information such as a taste of the user pre-registered into the receiving unit, an operational status of the receiving unit (including external environment information such as a switched-off loudspeaker), a kind or a format of the receiving unit, a use status of a power source and a cell or its residual quantity, and a kind and a status of an antenna (a shape of being folded in, its direction, etc.). Further, a configuration may be made so that the output signal information is automatically captured in the other formats. The output signal information may be inputted based upon information being automatically captured via a sensor installed inside or near to the receiving unit. For example, a quantity of the external noise, brightness, a time band, a geometric position, a temperature, information synchronous with video, barcode information captured through a camera, and so on may be employed as information being automatically captured.

The output signal information could be information having a sound source signal group, which is configured of a plurality of the sound source signals, as a unit instead of each sound source signal. Further, the output signal information could be information having a plurality of the frequency components as a unit instead of information represented frequency component by frequency component in some case and could be information obtained by collecting all of the frequency components in some cases.

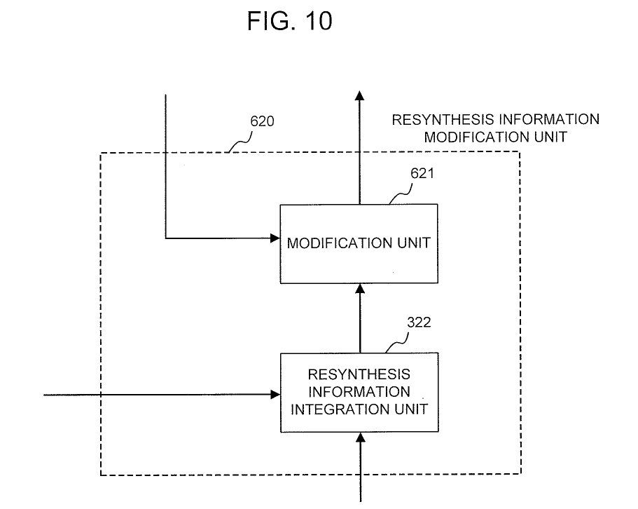

Continuously, a configuration example of the separation information calculation unit 102 of FIG. 10 will be explained in details. The separation information calculation unit 102 generates the separation information by analyzing the received multichannel input signal. And, the separation information calculation unit 102 outputs the separation information. The separation information, which is information representing a relation between the multichannel input signal and the sound source signal, is utilized for separating the multichannel input signal into a plurality of the sound source signals. As a method of generating the separation information, the technique that is called blind source separation or independent component analysis may be employed. The technology related to the methods of the blind source separation or the independent component analysis is disclosed in Literature 1 “Speech Enhancement, Springer, 2005, pp. 299-327”.

Hereinafter, an operational example of the separation information calculation unit 102 will be explained. At first, the separation information calculation unit 102 configures one block by collecting a plurality of input signal samples, and applies a frequency conversion for this block. As an example of the frequency conversion, a Fourier transform, a cosine transform, a KL (Karhunen Loeve) transform, etc. are known. The technology related to a specific arithmetic operation of these transforms, and its properties are disclosed in Literature 2 (DIGITAL CODING OF WAVEFORMS, PRINCIPLES AND APPLICATIONS TO SPEECH AND VIDEO, PRENTICE-HALL, 1990). Further, the separation information calculation unit 102 also can apply the foregoing transforms for a result obtained by weighting one block of the input signal samples with a window function. As such a window function, the window functions such as a Hamming window, a Hanning (Hann) window, a Kaiser window, and a Blackman window are known. Further, more complicated window functions can be employed. The technology related to these window functions is disclosed in Literature 3 (DIGITAL SIGNAL PROCESSING, PRENTICE-HALL, 1975) and Literature 4 (MULTIRATE SYSTEMS AND FILTER BANKS, PRENTICE-HALL, 1993). In addition, an overlap of each block may be permitted at the moment that the separation information calculation unit 102 configures one block from a plurality of the input signal samples. For example, with the case of applying an overlap of 30% of a block length, the last 30% of the signal sample belonging to a certain block is repeatedly employed in a plurality of the blocks as the first 30% of the signal sample belonging to the next block. The technology related to the blocking involving the overlap and the conversion is disclosed in the Literature 2.

In addition, as another example of the frequency conversion, a configuration may be made with a band-division filter bank. The band-division filter bank is configured of a plurality of band-pass filters. The band-division filter bank divides the received input signal into a plurality of frequency bands. An interval of each frequency band of the band-division filter bank could be equal in some cases, and unequal in some cases. Band-dividing the input signal at an unequal interval makes it possible to lower/raise a time resolution, that is, the time resolution can be lowered by dividing the input signal into narrows bands with regard to a low-frequency area, and the time resolution can be raised by dividing the input signal into wide bands with regard to a high-frequency area. As a typified example of the unequal-interval division, there exists an octave division in which the band gradually halves toward the low-frequency area, a critical band division that corresponds to an auditory feature of a human being, or the like. The technology related to the band-division filter bank and its design method is disclosed in the Literature 4.

Continuously, the separation information calculation unit 102 generates the separation information by employing the multichannel input signal subjected to the frequency conversion with the foregoing methods. The frequency component of the multichannel input signal in a certain frequency band f, the frequency component of a separated signal, and the frequency component of a separation matrix are defined as Xᵢ(f), i=1, 2, . . . , M (M is the number of the input channels), Yᵢ(f), i=1, 2, . . . , P (P is the number of the sound source signals), and W(f), respectively, and the separation matrix W(f) that behaves like the following [Numerical equation 1] is calculated.

$$[ \begin{matrix}{Y}_{1} ( f ) \\ {Y}_{2} ( f ) \\ ⋮ \\ {Y}_{P} ( f )\end{matrix} ] = W ( f ) \cdot [ \begin{matrix}{X}_{1} ( f ) \\ {X}_{2} ( f ) \\ ⋮ \\ {X}_{M} ( f )\end{matrix} ] \qquad [ Numerical equation 1 ]$$

Wherein, the separation matrix W(f) is a matrix with P rows and M columns that behaves like the following [Numerical equation 2].

$$W ( f ) = [ \begin{matrix}{w}_{11} ( f ) & {w}_{12} ( f ) & … & {w}_{1 , M} ( f ) \\ {w}_{21} ( f ) & {w}_{22} ( f ) & … & {w}_{2 , M} ( f ) \\ ⋮ & ⋮ & ⋱ & ⋮ \\ {w}_{P 1} ( f ) & {w}_{P 2} ( f ) & … & {w}_{PM} ( f )\end{matrix} ] \qquad [ Numerical equation 2 ]$$

The separation matrix W(f) is calculated so that independency of the separated signal Yᵢ(f) is maximized because the separated signal Yᵢ(f) is unknown as a rule. The technology related art of the method of calculating the separation matrix W(f) is disclosed in the Literature 1. The separation information calculation unit 102 outputs the separation matrix W(f) calculated for each frequency band as the separation information.

Next, a configuration example of the encoding unit 300 of FIG. 1 will be explained in details. The encoding unit 300 receives the multichannel input signal and the separation information, and generates the encoded multichannel input signal and the encoded separation information as the transmission signal by encoding the multichannel input signal and the separation information. And, the encoding unit 300 outputs the transmission signal to the transmission path.

At first, a specific example of encoding the multichannel input signal will be explained. The encoding unit 300 can encode the multichannel input signal by employing the encoding method such as AAC. After the multichannel input signal is frequency-converted, the redundancy of the signal frequency-converted by utilizing the auditory feature such as a masking effect and Huffman coding is removed when the AAC is employed, and the encoded multichannel input signal is generated.

Continuously, a specific example of encoding the separation information will be explained. The encoding unit 300 generates the encoded separation information by quantizing and encoding the separation matrix W(f), being the separation information. As a quantization method, the quantization methods such as a linear quantization method and a non-linear quantization method are known. The redundancy of the quantized separation information can be removed by employing the Huffman coding etc. In addition, so as to remove the redundancy of the separation information, the auditory feature such as an audible limit frequency can be utilized. For example, the separation information of the high frequency band that is hardly recognized auditorily may not be encoded and quantized. In addition, as a method of removing the redundancy of the separation information, the method may be used of quantizing and encoding the separation information after utilizing the auditory feature such as a critical bandwidth and integrating the separation information in a plurality of frequency bands. An interval of the frequency bands to be integrated could be equal in some cases, and unequal in some cases. Making the band-division into the bands having the unequal interval, namely, making the band-division into the narrows bands with regard to a low-frequency area and making the band-division into the wide bands with regard to a high-frequency area enables the matching to the auditory feature. All of the frequency bands may be consolidated into one. As a method of integrating the frequency bands, an average of respective elements that are included in the frequency band to be integrated may be employed. As another method of integrating the frequency bands, when the separation information is a complex numerical signal, the frequency bands may be integrated after dividing each element into an amplitude term and a phase term. For example, it is possible to employ an average of the amplitude terms of respective elements that are included in the frequency bands to be integrated for the amplitude term, and to employ the phase terms of respective elements as they stand without integration.

Next, a configuration example of the decoding unit 310 of FIG. 1 will be explained in details. The decoding unit 310 decodes the received transmission signal into the multichannel decoded signal and the decoded separation information. The decoding unit 310 outputs the multichannel decoded signal to the signal resynthesis unit 330, and the decoded separation information to the separation/resynthesis information generation unit 320, respectively.

At first, a specific example of decoding the encoded multichannel input signal will be explained. The decoding unit 310 generates the multichannel decoded signal by decoding the encoded multichannel input signal. The encoded multichannel input signal is decoded by employing the decoding method corresponding to the encoding method of the multichannel input signal employed by the encoding method 300. When the AAC is employed, at first, the encoded multichannel input signal is subjected to the Huffman decoding and the inverse quantization, and then the decoded converted signal of each channel that is configured of a plurality of the frequency components is generated. And, the decoded converted signal of each channel is subjected to then inverse frequency conversion channel by channel. As the inverse frequency conversion to be applied herein, the inverse conversion corresponding to the frequency conversion applied for the multichannel input signal in the encoding unit 300 is employed. For example, when the encoding unit 300 configures one block by collecting a plurality of the multichannel input signal samples, and applies the frequency conversion for this block, it applies the corresponding inverse conversion for an identical number of samples also in the inverse frequency conversion process. Further, when an overlap of each block is permitted at the moment that the encoding unit 300 configures one block from a plurality of the multichannel input signal samples, the identical overlap is applied for the inverse-converted signal also in the inverse frequency conversion process. In addition, when the encoding unit 300 is configured of a band-division filter bank, the inverse frequency conversion is configured of a band-synthesis filter bank. The technology related to the band-synthesis filter bank and its design method is disclosed in the Literature 4. The signal subjected to the inverse frequency conversion is outputted as the multichannel decoded signal.

Next, a specific example of decoding the encoded separation information will be explained. The decoding unit 310 generates the decoded separation information by decoding the encoded separation information. The encoded separation information is decoded by employing the decoding method corresponding to the encoding method of the separation information employed by the encoding unit 300. The encoded separation information is subjected to the decoding and the inverse quantization, and then decoded separation information is generated.

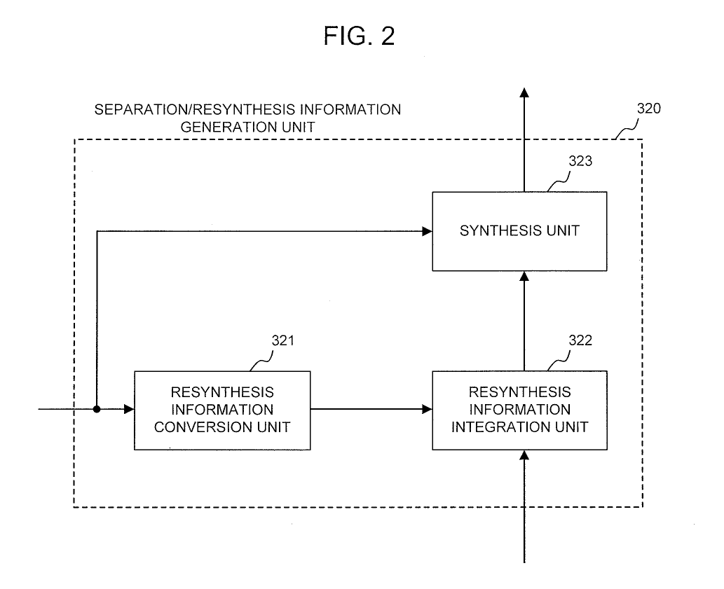

Next, a configuration example of the separation/resynthesis information generation unit 320 of FIG. 1 will be explained in details by making a reference to FIG. 2. The separation/resynthesis information generation unit 320 receives the decoded separation information and the output signal information, and outputs separation/resynthesis information. The separation/resynthesis information generation unit 320 is configured of a resynthesis information conversion unit 321, a resynthesis information integration unit 322, and a synthesis unit 323. The decoded separation information is inputted into the resynthesis information conversion unit 321 and the synthesis unit 323, and the output signal information is inputted into the resynthesis information integration unit 322.

The resynthesis information conversion unit 321 generates the decoded resynthesis information by converting the received decoded separation information. And, the resynthesis information conversion unit 321 outputs the decoded resynthesis information to the resynthesis information integration unit 322. Herein, the decoded resynthesis information represents a relation between a plurality of the sound source signals to be included in the multichannel input signal, and the multichannel input signal. That is, the decoded resynthesis information represents how the respective sound source signals have been mixed in the multichannel input signal received in the transmission unit, and includes the localization information of the respective sound source signals.

A specific example of calculating the decoded resynthesis information will be explained. Upon defining the frequency component of the decoded separation information in the frequency band f as WD(f), a frequency component UD(f) of the decoded resynthesis information behaves likes UD(f)=WD⁻¹(f), and can be represented by the inverse matrix of the decoded separation information. Where the decoded resynthesis information UD(f) is a matrix with M rows and P columns, M represents the number of the channels of the multichannel input signal, and P represents the number of the sound source signals.

The resynthesis information integration unit 322 generates the integrated resynthesis information by integrating the received decoded resynthesis information and the output signal information. And, the resynthesis information integration unit 322 outputs the integrated resynthesis information to the synthesis unit 323. At first, the resynthesis information integration unit 322 converts the decoded resynthesis information into converted resynthesis information. The converted resynthesis information represents a relation between a plurality of the sound source signals to be included in the multichannel input signal, and the multichannel output signal. A frequency component UT(f) of the converted resynthesis information in the frequency band f behaves like the following equation by employing a frequency component H(f) of the conversion matrix, and a frequency component UD(f) of the decoded resynthesis information.

$$UT ( f ) = H ( f ) \cdot UD ( f ) \\ H ( f ) = [ \begin{matrix}{h}_{11} ( f ) & … & {h}_{1 M} ( f ) \\ ⋮ & ⋱ & ⋮ \\ {h}_{N 1} ( f ) & … & {h}_{NM} ( f )\end{matrix} ] \qquad [ Numerical equation 3 ]$$

Wherein M, N, and P represents the number of the channels of the multichannel input signal, the number of the channels of the multichannel output signal, and the number of the sound source signals, respectively. H(f) is a matrix with N rows and M columns, and UT(f) becomes a matrix with N rows and P columns. The conversion matrix is a matrix for converting a channel configuration of the multichannel input signal into a channel configuration of the multichannel output signal. For example, when the channel configuration of the multichannel input signal is identical to that of the multichannel output signal, it follows that H(f) is a unit matrix, and UT(f)=UD(f) is yielded. When the number of the input channels is less than that of the output channels, the conversion matrix assumes an up-mixing operation. At this time, the conversion matrix may be configured so that the output channels of which the number is equivalent to a surplus are made soundless, and the conversion matrix may be configured so that a plurality of the input channels are blended and divided in order to match the output channels in the number. On the other hand, when the number of the input channels is more than that of the output channels, the conversion matrix assumes a down-mixing operation. At this time, the conversion matrix may be configured so that a plurality of the input channels are blended in order to match the output channels in the number, and the conversion matrix may be configured so that the specific input channels are selected in order to match the output channels in the number. As the conversion matrix, a pre-decided matrix may be employed in some cases, and the matrix that is changed according to the features of the multichannel input signal and the multichannel output signal may be employed in some cases. Further, the matrix may be changed as time lapses.

Continuously, the resynthesis information integration unit 322 generates integrated resynthesis information by integrating the converted resynthesis information and the output signal information. And, the resynthesis information integration unit 322 outputs the integrated resynthesis information. The integrated resynthesis information represents a relation between the sound source signal and the multichannel output signal. As a method of the integration, the integration can be carried out by selecting which information, out of the converted resynthesis information and the output signal information, is employed for each sound source signal. As another method, not the method of making a selection for each sound source signal, but the method of carrying out the integration with the sound source signal group obtained by collecting a plurality of the sound source signals defined as a unit may be used. Further, for all of the sound source signals, only one side's information, out of the converted resynthesis information and the output signal information, may be selected at any time, and employed as the integrated resynthesis information instead of making a selection for each sound source signal. For example, employing the converted resynthesis information at any time makes it possible to reflect sender's intention.

A specific example of calculating the integrated resynthesis information will be explained. The frequency component U(f) of the output signal information in the frequency band f, and the frequency component U(f) of the converted resynthesis information are represented as follows.

$$U ( f ) = [ \begin{matrix}{u}_{1} ( f ) & … & {u}_{P} ( f )\end{matrix} ] \\ UT ( f ) = [ \begin{matrix}{ut}_{1} ( f ) & … & {ut}_{P} ( f )\end{matrix} ] \\ {u}_{1} ( f ) = [ \begin{matrix}{u}_{1 i} ( f ) \\ ⋮ \\ {u}_{N i} ( f )\end{matrix} ] , {ud}_{i} ( f ) = [ \begin{matrix}{ut}_{1 i} ( f ) \\ ⋮ \\ {ut}_{Ni} ( f )\end{matrix} ] \qquad [ Numerical equation 4 ]$$

Wherein P represents the number of the sound source signals, and M represents the number of the channels of the multichannel output signal. When the frequency component of the integrated resynthesis information in the frequency band f is defined to be UC(f), the frequency component UC(f) of the integrated resynthesis information behaves like the following equation by employing Numerical equation 4.

$$[ Numerical equation 5 ]$$

$$UC ( f ) = [ \begin{matrix}{uc}_{1} ( f ) & … & {uc}_{P} ( f )\end{matrix} ]$$

$${uc}_{i} ( f ) = \{ \begin{matrix}{u}_{i} ( f ) ( \begin{matrix}when using resynthesis information \\ in terms of sound source i\end{matrix} ) \\ {ut}_{i} ( f ) ( \begin{matrix}when using decoded resynthesis information \\ in terms of to sound source i\end{matrix} )\end{matrix}$$

Wherein UC(f) is a matrix with N rows and P columns. Which information, out of the output signal information and the converted resynthesis information is employed for each sound source signal may be selected according to a taste of the user in some cases, and by use of a pre-decided method in some cases. In addition, the integration method such as a method of selecting the converted resynthesis information for a specific sound source signal at any time may be employed.

The synthesis unit 323 generates the separation/resynthesis information by synthesizing the received decoded separation information and integrated resynthesis information. And, the synthesis unit 323 outputs the separation/resynthesis information. The separation/resynthesis information represents information for separating the multichannel decoded signal into respective sound source signals, and taking a control for each sound source signal. Upon defining the frequency component of the decoded separation information in the frequency band f as WD(f), and the frequency component of the integrated resynthesis information as UC(f), respectively, the frequency component UW(f) of the separation/resynthesis information behaves like UW(f)=UC(f)×WD(f). UW(f) becomes a matrix with N rows and M columns.

Next, now returning to FIG. 1, a configuration example of the signal resynthesis unit 330 will be explained in details. The signal resynthesis unit 330 receives the multichannel decoded signal and the separation/resynthesis information, and generates the multichannel output signal by independently modifying a plurality of the sound source signals constituting the multichannel decoded signal based upon the separation/resynthesis information. The signal resynthesis unit 330 outputs the multichannel output signal.

Hereinafter, an operational example of the signal resynthesis unit 330 will be explained. At first, the signal resynthesis unit 330 performs the frequency conversion for the multichannel decoded signal. A method of the frequency conversion is similar to the method of the frequency conversion explained in the separation information calculation unit 102, so its explanation is omitted. Upon defining the frequency component of the multichannel decoded signal in the frequency band f as XDᵢ(f), i=1, 2, . . . , M (M is the number of the input channels), and the frequency component of the separation/resynthesis information as UW(f), respectively, a frequency component Zᵢ(f), i=1, 2, . . . , N (N is the number of the output channels) of the controlled signal behaves like the following equation.

$$[ \begin{matrix}{Z}_{1} ( f ) \\ {Z}_{2} ( f ) \\ ⋮ \\ {Z}_{N} ( f )\end{matrix} ] = UW ( f ) \cdot [ \begin{matrix}{XD}_{1} ( f ) \\ {XD}_{2} ( f ) \\ ⋮ \\ {XD}_{M} ( f )\end{matrix} ] \qquad [ Numerical equation 6 ]$$

UW(f) is a matrix with N rows and M columns. Continuously, the signal resynthesis unit 330 performs the inverse frequency conversion for the frequency component of the controlled signal. A method of the inverse frequency conversion is similar to the method of the inverse frequency conversion explained in the decoding unit 310, so its explanation is omitted. And, the signal resynthesis unit 330 outputs the signal subjected to the inverse frequency conversion as the multichannel output signal.

Another operational example of the signal resynthesis unit 330 will be explained. At first, the signal resynthesis unit 330 performs the inverse frequency conversion for the frequency component of the separation/resynthesis information, and generates an impulse response (filter coefficient). A method of the inverse frequency conversion is similar to the method of the inverse frequency conversion explained in the decoding unit 310, so its explanation is omitted. And, the signal resynthesis unit 330 generates the multichannel output signal by convoluting the multichannel decoded signal with the impulse response.

While the AAC was estimated for encoding and decoding the multichannel input signal in the above-mentioned explanation of the encoding unit 300 and the decoding unit 310, Pulse Code Modulation (PCM), Adaptive Differential Pulse Code Modulation (ADCM), and Analysis/Synthesis Coding to be typified by CELP besides them may be applied. The technology related to the PCM/ADPCM is disclosed in the Literature 2. Further, the technology related to the CELP is disclosed in Literature 5 (IEEE INTERNATIONAL CONFERENCE ON ACOUSTICS, SPEECH, AND SIGNAL PROCESSING, 25.1.1, MARCH 1985. pp. 937-940). Further, the encoding unit 300 may transmit the multichannel input signal as it stands without performing the encoding process for the multichannel input signal, and the decoding unit 310 may output the multichannel input signal as the multichannel decoded signal to the signal resynthesis unit 330 without performing the decoding process as it stands. With this configuration, the distortion of the signal to be accompanied by the encoding/decoding process can be eliminated. This configuration enables the signal resynthesis unit 330 to receive the multichannel decoded signal without yielding distortion in the multichannel input signal.

As explained above, the first embodiment of the present invention enables the receiving unit to take a control for each sound source signal based upon the output signal information, and the separation information to be outputted from the transmission unit. That is, the first embodiment enables the receiving unit to localize a desired sound source signal in a desired position, and to suppress or emphasize it. Further, localization information identical to that of the multichannel input signal received by the transmission unit can be easily reproduced in the receiving unit because the localization information of each sound source signal constituting the multichannel input signal received by the transmission unit can be kept.

### Second Embodiment

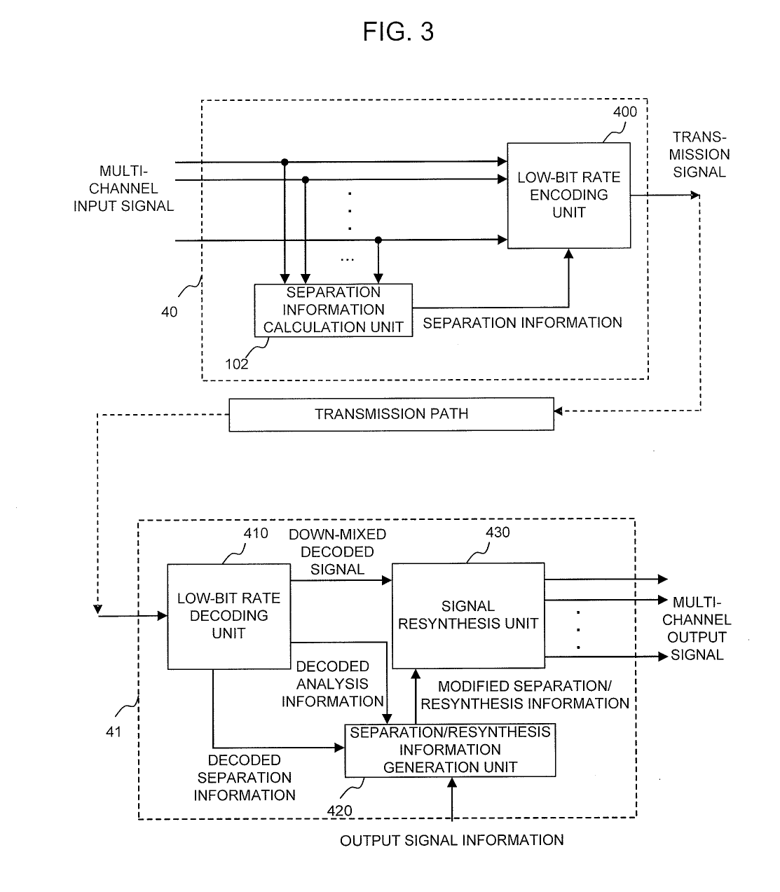

A second embodiment of the present invention will be explained by making a reference to FIG. 3. The second embodiment assumes a configuration in which a transmission unit 40 and a receiving unit 41 are connected via the transmission path. The transmission unit 40 receives the multichannel input signal having a plurality of the sound source signals mixed therein, and outputs the transmission signal. The transmission signal is inputted into the receiving unit 41 via the transmission path. The receiving unit 41 receives the transmission signal and the output signal information, and outputs the multichannel output signal.

The transmission unit 40 receives the multichannel input signal having a plurality of the sound source signals mixed therein, and outputs the transmission signal. The transmission unit 40 is configured of a separation information calculation unit 102 and a low-bit rate encoding unit 400. The multichannel input signal is inputted into the separation information calculation unit 102 and the low-bit rate encoding unit 400. The separation information calculation unit 102 generates the separation information for separating the multichannel input signal into a plurality of the sound source signals. And, the separation information calculation unit 102 outputs the separation information to the low-bit rate encoding unit 400. The low-bit rate encoding unit 400 generates the transmission signal by encoding the multichannel input signal, and the separation information received from the separation information calculation unit 102. And, the low-bit rate encoding unit 400 outputs the transmission signal to the transmission path. The transmission unit 40, as compared with the transmission unit 30 of FIG. 1 representing the first embodiment, differs in a point that the decoding unit 300 is replaced with the low-bit rate encoding unit 400.

The receiving unit 41 receives the transmission signal and the output signal information, and outputs the multichannel output signal. The receiving unit 41 is configured of a low-bit rate decoding unit 410, a separation/resynthesis information generation unit 420, and a signal resynthesis unit 430. The transmission signal is inputted into the low-bit rate decoding unit 410. The output signal information is inputted into the separation/resynthesis information generation unit 420. At first, the low-bit rate decoding unit 410 decodes the received transmission signal into a down-mixed decoded signal, decoded analysis information, and decoded separation information. Continuously, the low-bit rate decoding unit 410 outputs the down-mixed decoded signal to the signal resynthesis unit 430, and the decoded analysis information and the decoded separation information to the separation/resynthesis information generation unit 420, respectively. The separation/resynthesis information generation unit 420 generates modified separation/resynthesis information by integrating the output signal information, and the decoded analysis information and decoded separation information received from the low-bit rate decoding unit 410. And, the separation/resynthesis information generation unit 420 outputs the modified separation/resynthesis information to the signal resynthesis unit 430. The signal resynthesis unit 430 resynthesizes the multichannel output signal by modifying the down-mixed decoded signal received from the low-bit rate decoding unit 410 based upon the modified separation/resynthesis information received from the separation/resynthesis information generation unit 420. And, the signal resynthesis unit 430 outputs the multichannel output signal. The receiving unit 41, as compared with the receiving unit 31 of FIG. 1 representing the first embodiment, differs in a point that the decoding unit 300, the separation/resynthesis information generation unit 320, and the signal resynthesis unit 330 are replaced with the low-bit rate decoding unit 400, the separation/resynthesis information generation unit 420, and the signal resynthesis unit 430, respectively.

The output signal information is information for outputting a plurality of the sound source signals to be included in the multichannel input signal to a plurality of the output channels, respectively, as explained in the first embodiment.

Hereinafter, explanation of a part in which the second embodiment overlaps the first embodiment is omitted, and a configuration example of the low-bit rate encoding unit 400, the low-bit rate decoding unit 400, the separation/resynthesis information generation unit 420, and the signal resynthesis unit 430 that are characteristic in this embodiment will be explained.

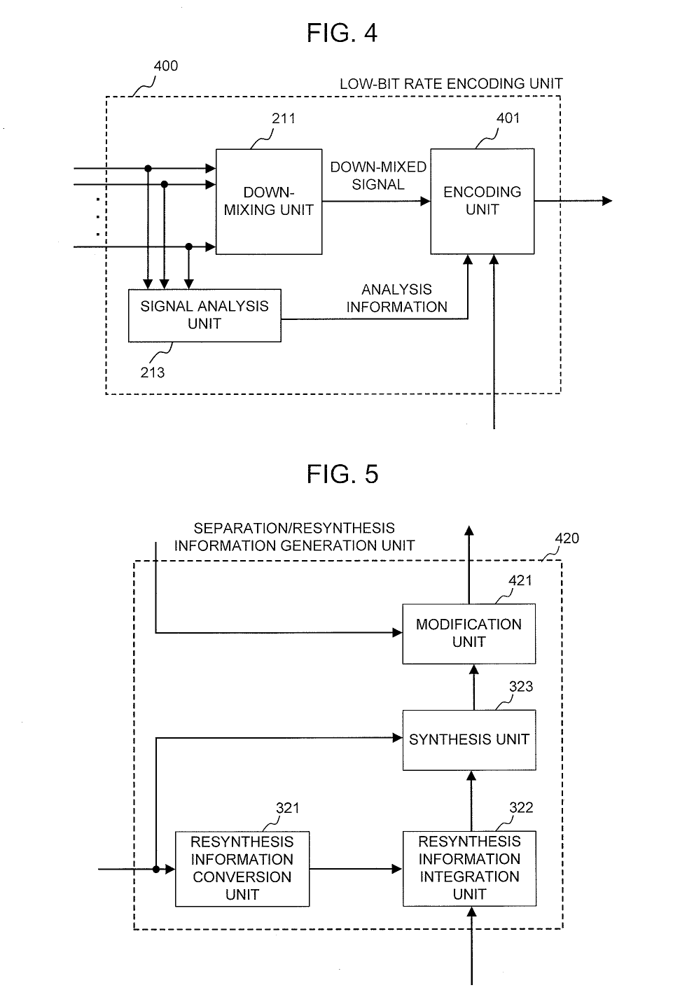

At first, a configuration example of the low-bit rate encoding unit 400 will be explained in details by making a reference to FIG. 4. The low-bit rate encoding unit 400 generates the transmission signal by encoding the received multichannel input signal and separation information. And, the low-bit rate encoding unit 400 outputs the transmission signal. The low-bit rate encoding unit 400 is configured of a down-mixing unit 211, a signal analysis unit 213, and an encoding unit 401. The multichannel input signal is inputted into the signal analysis unit 213 and the down-mixing unit 211, and the separation information is inputted into the encoding unit 401.

The down-mixing unit 211 generates the down-mixed signal by down-mixing the multichannel input signal. And, the down-mixing unit 211 outputs the down-mixed signal to the encoding unit 401.

The down-mixing process in the down-mixing unit 211 is capable of generating the one-channel down-mixed signal by summing up all of the multichannel input signals. Further, plural-channel down-mixed signal may be generated by dividing the multichannel input signals into a plurality of groups, and summing up the multichannel input signals belonging to each group. Additionally, instead of summing up the multichannel input signals as they stand, the multichannel input signals may be summed up after compensating a phase difference/correlation between the multichannel input signals.

As another down-mixing process in the down-mixing unit 211, the down-mixed signal can be generated by performing the frequency conversion for the multichannel input signal, and summing up the multichannel input signals subjected to the frequency conversion frequency component by frequency component. The frequency conversion can be employed for a process similar to that of the frequency conversion that is performed by the separation information calculation unit 102, so its explanation is omitted. At this time, the converted multichannel input signals subjected to an energy correction or a phase difference compensation, which differs frequency component by frequency component, may be summed up. The fine down-mixing process can be realized as compared with the case of performing the down-mixing process in a time region because the down-mixing process is performed in a frequency region.

The signal analysis unit 213 generates the analysis information by analyzing the received multichannel input signal. And, the signal analysis unit 213 outputs the analysis information to the encoding unit 401. Herein, the analysis information, which is information representing a relation between the multichannel input signal and the down-mixed signal frequency component by frequency component, can be represented by employing an energy difference, a time difference, and a correlation between the signals, and the like. As one example of the analysis information, the information disclosed in literature 6 (ISO/IEC 23003-1:2007 Part 1 MPEG Surround) is known. At first, the signal analysis unit 213 performs the frequency conversion for the received multichannel input signal. As the frequency conversion, a process similar to that of the frequency conversion in the separation information calculation unit 102 may be employed, so its explanation is omitted. Continuously, the signal analysis unit 213 calculates an energy difference, a time difference, and a correlation between the signals, and the like by analyzing the signal subjected to the frequency conversion. And, the signal analysis unit 213 generates the analysis information based upon the calculated energy difference, time difference, and correlation between the signals, and the like. The technology related to the generation of the analysis information is disclosed in the Literature 6.

The encoding unit 401 generates the encoded down-mixed signal, the encoded analysis information, and the encoded separation information as the transmission signal by encoding the received down-mixed signal, analysis information and separation information. And, the encoding unit 401 outputs the transmission signal to the transmission path.

At first, a specific example of encoding the down-mixed signal will be explained. The encoding unit 401 generates the encoded down-mixed signal by encoding the down-mixed signal. As a method of encoding the down-mixed signal, a process similar to the process of encoding the multichannel input signal explained in the encoding unit 300 of the first embodiment may be employed, so its explanation is omitted.

Continuously, a specific example of encoding the analysis information will be explained. The encoding unit 401 generates the encoded analysis information by encoding the analysis information. As a method of encoding the analysis information, there exists the quantization method disclosed in the Literature 6. As a quantization method, the quantization methods such as a linear quantization method and a non-linear quantization method are known. The redundancy of the quantized analysis information can be removed by employing the Huffman coding etc. In addition, so as to remove the redundancy of the analysis information, the auditory feature such as an audible limit frequency can be utilized. For example, the separation information of the high frequency band that is hardly recognized auditorily may not be encoded and quantized. In addition, as a method of removing the redundancy of the analysis information, the method can be used of quantizing and encoding the analysis information after utilizing the auditory feature such as a critical bandwidth and integrating the analysis information in a plurality of frequency bands. An interval of the frequency bands to be integrated could be equal in some cases, and unequal in some cases. Making the band-division into the bands having the unequal interval, namely, making the band-division into the narrows bands with regard to a low-frequency area and making the band-division into the wide bands with regard to a high-frequency area enables the matching to the auditory feature. All of the frequency bands may be consolidated into one. As a method of integrating the frequency bands, an average of the respective elements that are included in the frequency bands to be integrated may be employed. With regard to the information quantity for encoding the analysis information, the analysis information can be encoded with a smaller information quantity as compared with the case of encoding the multichannel input signal channel by channel.

Continuously, a specific example of encoding the separation information will be explained. The encoding unit 401 generates the encoded separation information by encoding the separation information. The process of encoding the separation information is one explained in the encoding unit 300 of the first embodiment, so its explanation is omitted.

Next, now returning to FIG. 3, a configuration example of the low-bit rate decoding unit 410 will be explained in details. The low-bit rate decoding unit 410 decodes the received transmission signal into the down-mixed decoded signal, the decoded analysis information, and the decoded separation information. The low-bit rate decoding unit 410 outputs the down-mixed decoded signal to the signal resynthesis unit 430, and the decoded analysis information and the decoded separation information to the separation/resynthesis information generation unit 420, respectively.

At first, a specific example of decoding the encoded down-mixed signal will be explained. The low-bit rate decoding unit 410 generates the down-mixed decoded signal by decoding the encoded down-mixed signal. As a method of decoding the encoded down-mixed signal, the decoding method corresponding to the method of encoding the down-mixed signal employed by the encoding unit 401 is employed. As a process of decoding the encoded down-mixed signal, a process similar to the process of decoding the encoded multichannel input signal in the decoding unit 310 of the first embodiment may be employed, so its explanation is omitted.

Continuously, a specific example of decoding the encoded analysis information will be explained. The low-bit rate decoding unit 410 generates the decoded analysis information by decoding the encoded analysis information. As a method of decoding the encoded analysis information, the decoding method corresponding to the method of encoding the analysis information employed by the encoding unit 401 is employed. The encoded analysis information is decoded and inverse-quantized, and the decoded analysis information is generated.

Continuously, a specific example of decoding the encoded separation information will be explained. The low-bit rate decoding unit 410 generates the decoded separation information by decoding the encoded separation information. As a method of decoding the encoded separation information, the decoding method corresponding to the method of encoding the separation information employed by the encoding unit 401 is employed. The process of decoding the encoded separation information is one explained in the decoding unit 310 of the first embodiment, so its explanation is omitted.

Continuously, a configuration example of the separation/resynthesis information generation unit 420 of FIG. 3 will be explained in details by making a reference to FIG. 5. The separation/resynthesis information generation unit 420 receives the decoded analysis information, the decoded separation information, and the output signal information, and outputs the modified separation/resynthesis information. The separation/resynthesis information generation unit 420 is configured of a resynthesis information conversion unit 321, a resynthesis information integration unit 322, a synthesis unit 323, and a modification unit 421. The decoded analysis information is inputted into the modification unit 421. The decoded separation information is inputted into the resynthesis information conversion unit 321 and the synthesis unit 323. The output signal information is inputted into the resynthesis information integration unit 322. The separation/resynthesis information generation unit 420, as compared with the separation/resynthesis information generation unit 320 of the first embodiment of FIG. 2, differs in a point that the modification unit 421 is newly added. Hereinafter, the modification unit 421 will be explained.

The modification unit 421 receives the separation/resynthesis information and the decoded analysis information, and outputs the modified separation/resynthesis information by modifying the separation/resynthesis information based upon the decoded analysis information. The modified separation/resynthesis information represents information for separating the down-mixed decoded signal into respective sound source signals, and taking a control for each separated sound source signal. Upon defining the frequency component of the decoded analysis information in the frequency band f as A(f), and the frequency component of the separation/resynthesis information as UW(f), respectively, the frequency component UWA(f) of the modified separation/resynthesis information behaves like UWA(f)=UW(f)×A(f). Herein, upon defining the number of the channels of the multichannel input signal, the number of the channels of the down-mixed signal, the number of the sound source signals, and the number of the channels of the multichannel output signal as M, Q, P, and N, respectively, A(f) and UW(f) become a matrix with M rows and Q columns, and a matrix with N rows and M columns, respectively, and UWA(f) becomes a matrix with N rows and Q columns.

Next, now returning to FIG. 3, a configuration example of the signal resynthesis unit 430 will be explained in details. The signal resynthesis unit 430 receives the down-mixed decoded signal and the modified separation/resynthesis information, and generates the multichannel output signal by independently modifying a plurality of the sound source signals constituting the down-mixed decoded signal based upon the modified separation/resynthesis information. The signal resynthesis unit 430 outputs the multichannel output signal.

Hereinafter, an operational example of the signal resynthesis unit 430 will be explained. At first, the signal resynthesis unit 430 performs the frequency conversion for the down-mixed decoded signal. A method of the frequency conversion is similar to the method of the frequency conversion explained in the encoding unit 300 of the first embodiment, so its explanation is omitted. Upon defining the frequency component of the down-mixed decoded signal in the frequency band f as MDᵢ(f), i=1, 2, . . . , Q (Q is the number of the channels of the down-mixed signal), and the frequency component of the modified separation/resynthesis information as UWA(f), respectively, the frequency component Zᵢ(f), i=1, 2, . . . , N (N is the number of the output channels) of the controlled signal behaves like the following equation.

$$[ \begin{matrix}{Z}_{1} ( f ) \\ {Z}_{2} ( f ) \\ ⋮ \\ {Z}_{N} ( f )\end{matrix} ] = UWA ( f ) \cdot [ \begin{matrix}{MD}_{1} ( f ) \\ {MD}_{2} ( f ) \\ ⋮ \\ {MD}_{Q} ( f )\end{matrix} ] \qquad [ Numerical equation 7 ]$$

UWA(f) is a matrix with N rows and Q columns. Continuously, the signal resynthesis unit 430 performs the inverse frequency conversion for the frequency component of the controlled signal. A method of the inverse frequency conversion is similar to the method of the inverse frequency conversion explained in the decoding unit 310 of the first embodiment, so its explanation is omitted. And, the signal resynthesis unit 430 outputs the signal subjected to the inverse frequency conversion as the multichannel output signal.

Another operational example of the signal resynthesis unit 430 will be explained. At first, the signal resynthesis unit 430 performs the inverse frequency conversion for the modified separation/resynthesis information, and generates the impulse response (filter coefficient). A method of the inverse frequency conversion is similar to the method of the inverse frequency conversion explained in the decoding unit 310, so its explanation is omitted. And, the signal resynthesis unit 430 can generate the multichannel output signal by convoluting the down-mixed decoded signal with the impulse response.

As explained above, the second embodiment of the present invention enables the receiving unit to take a control for each sound source signal based upon the output signal information, and the separation information to be outputted from the transmission unit. That is, the second embodiment enables the receiving unit to localize a desired sound source signal in a desired position, and to suppress or emphasize it. Further, the localization information identical to that of the multichannel input signal received by the transmission unit can be easily reproduced in the receiving unit because the localization information of each sound source signal constituting the multichannel input signal received by the transmission unit can be kept. In addition, the second embodiment, as compared with the first embodiment, enables the information quantity of the transmission signal to be curtailed because the multichannel input signal is encoded with a smaller information quantity.

### Third Embodiment

A third embodiment of the present invention will be explained by making a reference to

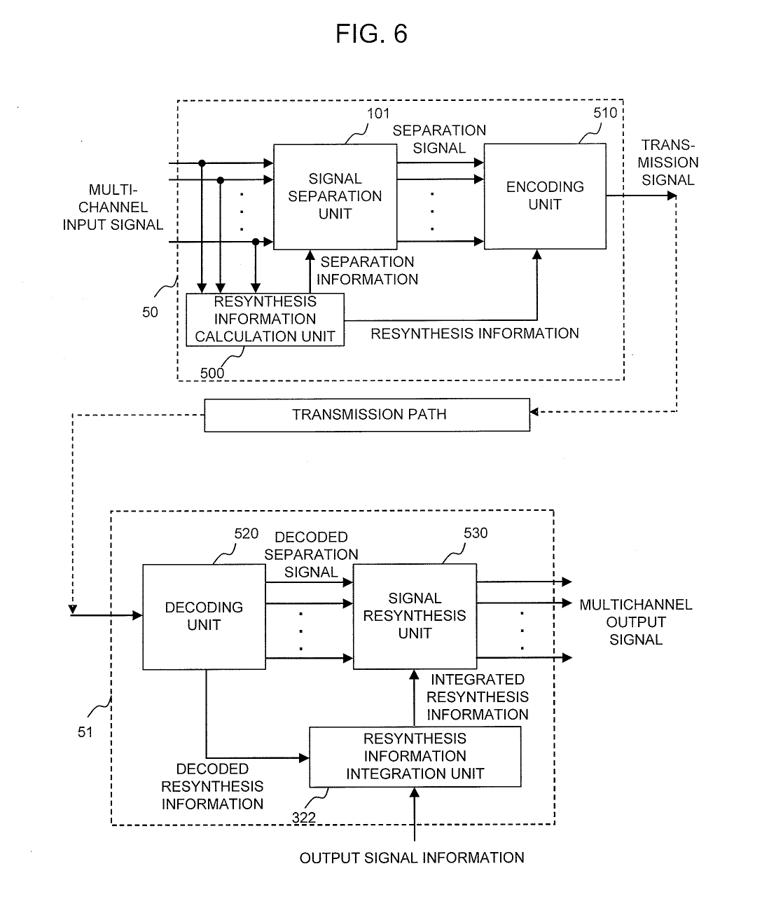

FIG. 6. The third embodiment assumes a configuration in which a transmission unit 50 and a receiving unit 51 are connected via the transmission path. The transmission unit 50 receives the multichannel input signal having a plurality of the sound source signals mixed therein, and outputs the transmission signal. The transmission signal is inputted into the receiving unit 51 via the transmission path. The receiving unit 51 receives the transmission signal and the output signal information, and outputs the multichannel output signal.

The transmission unit 50 receives the multichannel input signal having a plurality of the sound source signals mixed therein, and outputs the transmission signal. The transmission unit 50 is configured of a resynthesis information calculation unit 500, a signal separation unit 101, and an encoding unit 510. The multichannel input signal is inputted into the resynthesis information calculation unit 500 and the signal separation unit 101. The resynthesis information calculation unit 500 generates the separation information for separating the multichannel input signal into a plurality of the sound source signals, and the resynthesis information representing a relation between a plurality of the sound source signals constituting the multichannel input signal and the multichannel input signal. And, the resynthesis information calculation unit 500 outputs the separation information to the signal separation unit 101, and the resynthesis information to the encoding unit 510, respectively. The signal separation unit 101 receives the multichannel input signal and the separation information, and generates the separated signal by separating the multichannel input signal. And, the signal separation unit 101 outputs the separated signal to the encoding unit 510. The encoding unit 510 generates the transmission signal by encoding the separated signal received from the signal separation unit 101, and the resynthesis information received from the synthesis information calculation unit 500. And, the encoding unit 510 outputs it to the transmission path. The transmission unit 50, as compared with the transmission unit 30 of FIG. 1 representing the first embodiment, differs in a point that the separation information calculation unit 102 and the encoding unit 300 are replaced with the resynthesis information calculation unit 500 and the encoding unit 510, respectively, and a point of newly including the signal separation unit 101.

The receiving unit 51 receives the transmission signal and the output signal information, and outputs the multichannel output signal. The receiving unit 51 is configured of a decoding unit 520, a resynthesis information integration unit 322, and a signal resynthesis unit 530. The transmission signal is inputted into the decoding unit 520. The output signal information is inputted into the resynthesis information integration unit 322. At first, the decoding unit 520 decodes the received transmission signal into the decoded separated signal and the decoded resynthesis information. Continuously, the decoding unit 520 outputs the decoded separated signal to the signal resynthesis unit 530, and the decoded resynthesis information to the resynthesis information integration unit 322, respectively. The resynthesis information integration unit 322 generates the integrated resynthesis information by integrating the output signal information, and the decoded resynthesis information received from the decoding unit 520. And, the resynthesis information integration unit 322 outputs the integrated resynthesis information to the signal resynthesis unit 530. The signal resynthesis unit 530 resynthesizes the multichannel output signal by modifying the decoded separated signal received from the decoding unit 520 based upon the integrated resynthesis information received from the resynthesis information integration unit 322. The signal resynthesis unit 530 outputs the multichannel output signal. The receiving unit 51, as compared with the receiving unit 31 of FIG. 1 representing the first embodiment, differs in a point that the decoding unit 310, the separation/resynthesis information generation unit 320, and the signal resynthesis unit 330 are replaced with the decoding unit 520, the resynthesis information integration unit 322, and the signal resynthesis unit 530, respectively.

The resynthesis information is information representing a relation between a plurality of the sound source signals to be included in the multichannel input signal and the multichannel input signal. That is, the resynthesis information represents how the respective sound source signals have been mixed in the multichannel input signal, and includes the localization information of the respective sound source signals. This embodiment, which differs from the first embodiment and the second embodiment transmitting the separation information to the receiving unit, is characterized in transmitting the resynthesis information.

The output signal information is one already explained in the first embodiment. Additionally, the output signal information of this embodiment may be inputted according to a taste of the user after the user views the multichannel output signal generated based upon the transmitted resynthesis information. In this case, the output signal information does not need to be inputted for each sound source in the beginning, and thus, convenience of the user is improved.

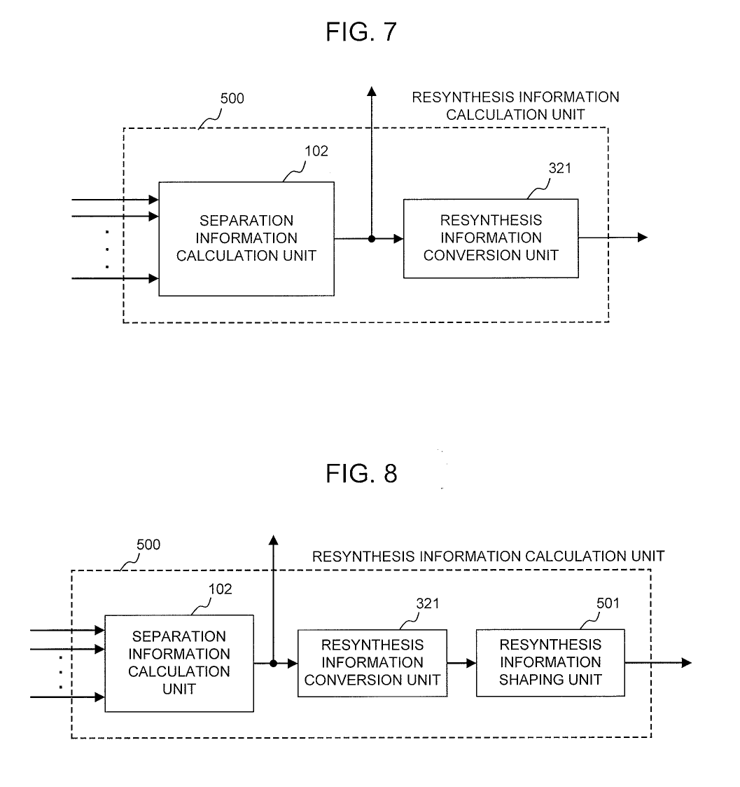

Continuously, a first configuration example of the resynthesis information calculation unit 500 of FIG. 6 will be explained in details by making a reference to FIG. 7. The resynthesis information calculation unit 500 receives the multichannel input signal, and outputs the separation information and the resynthesis information. The resynthesis information calculation unit 500 is configured of a separation information calculation unit 102 and a resynthesis information conversion unit 321. The separation information calculation unit 102 receives the multichannel input signal, and generates separation information, being information for separating the multichannel input signal into a plurality of the sound source signals, by analyzing the multichannel input signal. And, the separation information calculation unit 102 outputs the separation information. The separation information calculation unit 102 is similar to one employed in the first embodiment, so its explanation is omitted. The resynthesis information conversion unit 321 generates the resynthesis information by converting the received separation information. And, the separation information calculation unit 102 outputs the resynthesis information. The resynthesis information conversion unit 321 is similar to one employed in the first embodiment, so its explanation is omitted. The resynthesis information conversion unit 321 of this embodiment converts the resynthesis information based upon the separation information not subjected to the encoding/decoding. This makes it possible to generate more precise resynthesis information.

Next, a second configuration example of the resynthesis information calculation unit 500 will be explained in details by making a reference to FIG. 8. The resynthesis information calculation unit 500 receives

the multichannel input signal, and outputs the separation information and the resynthesis information. The second configuration example, as compared with the first configuration example of FIG. 7, is characterized in newly adding a resynthesis information shaping unit 501. The resynthesis information shaping unit 501 shapes the resynthesis information received from the resynthesis information conversion unit 321, and outputs the shaped resynthesis information.

Hereinafter, an operational example of the resynthesis information shaping unit 501 that is characteristic of the second configuration example will be explained in details. At first, the resynthesis information shaping unit 501 estimates an arrival direction of each sound source from the received resynthesis information. As a method of estimating the arrival direction, the localization information of each sound source to be included in the resynthesis information can be employed. A specific example of calculating the arrival direction will be explained. The frequency component UE(f) of the resynthesis information in the frequency band f is represented as follows.

$$UE ( f ) = [ \begin{matrix}{ue}_{1} ( f ) & … & {ue}_{P} ( f )\end{matrix} ] \\ {ue}_{i} ( f ) = [ \begin{matrix}{ue}_{1 i} ( f ) \\ ⋮ \\ {ue}_{Mi} ( f )\end{matrix} ] \qquad [ Numerical equation 8 ]$$

Where P represents the number of the sound source signals, and M represents the number of the channels of the multichannel input signal. UE(f) is a matrix with M rows and P columns, and each column of the resynthesis information represents a relation between each sound source and the multichannel input signal. That is, the arrival direction of the sound source signal i can be calculated by employing ueᵢ(f).

For example, it is assumed that the number of the channels of the multichannel input signal is two (M=2) of a left channel and a right channel, and the sound source signal i is propagated through air etc. and arrives at two channels. At this time, dᵢ(f)=ue₂ᵢ(f)/ue₁ᵢ(f) can be employed as information for calculating the arrival direction of the sound source signal i. When dᵢ(f) is a complex numerical signal, the amplitude term of dᵢ(f) represents a ratio of signal magnitude of the sound source signal i having arrived at the left channel and the sound source signal i having arrived at the right channel. On the other hand, the phase term represents a time difference between the sound source signal i having arrived at the left channel and the sound source signal i having arrived at the right channel. A frequency component doaᵢ(f) in the arrival direction can be calculated based upon the amplitude term and the phase term of dᵢ(f). The frequency component may be generated by employing either the amplitude term or the phase term, and may be generated by employing both at the moment of calculating the frequency component in the arrival direction. For example, when the phase term is not employed, and only the amplitude term is employed, the sound source signal i exists nearer to the center as the value of the amplitude term of dᵢ(f) becomes closer to 1. On the other hand, the sound source signal i exists in the left direction or in the right direction all the more as the value of the amplitude term of dᵢ(f) becomes larger than 1 or smaller than 1. As a method of calculating the arrival direction, there exists the method of converting dᵢ(f) in the arrival direction according a pre-decided function. This function could be a linear function, and could be non-linear function. Further, this function is changed according to a feature of the multichannel input signal. The technology related to the calculation of the arrival direction employing the resynthesis information UE(f) is disclosed in the Literature 1.

When the number of the channels of the multichannel input signal is two or more, the arrival direction can be calculated from a pair of specific channels. Further, the arrival direction may be calculated by using a plurality of pairs to integrate the calculated arrival directions. Calculating the arrival direction by using a plurality of pairs makes it possible to calculate the arrival directions of which a precision is high.

While the method of calculating the arrival direction frequency component by frequency component was exemplified in the above-mentioned explanation of the estimation of the arrival direction, the arrival direction may be calculated after collecting the resynthesis information of a plurality of the frequency bands. Or the arrival direction common to a plurality of the frequency bands may be calculated from the arrival directions estimated for respective frequency bands. For example, the arrival direction common to a plurality of the frequency bands may be calculated by weight-averaging the arrival directions of respective frequency bands using the weight responding to the estimation precision of the arrival directions of respective frequency band. As the weight responding to the estimation precision, the energy of each frequency band of the separated signal can be employed. For example, making the weight of the frequency band having large energy large, and the weight of the frequency band having small energy small enables an influence upon the arrival direction by the component having small energy, which is hard to hear, to be removed. In addition, the weight can be calculated based upon the auditory feature of a human being such as a masking effect. For example, an importance degree of the auditory feeling calculated for each frequency component by utilizing the masking effect may be employed as the weight. This weighting makes it possible to estimate the arrival direction in conformity with the auditory feature of a human being. In addition, the arrival direction of the sound source, which is emitted from a common one point irrespective of the frequency, may be also estimated commonly to all of the frequency bands.

Continuously, the resynthesis information shaping unit 501 regenerates the resynthesis information based upon the estimated arrival direction of each sound source. And, the resynthesis information shaping unit 501 outputs the regenerated resynthesis information. By employing a frequency component doaᵢ(f) of the arrival direction, a frequency component UE'(f) of the regenerated resynthesis information behaves like the following equation.

$${UE}^{′} ( f ) = [ \begin{matrix}{ue}_{1}^{′} ( f ) & … & {ue}_{P}^{′} ( f )\end{matrix} ] \\ {ue}_{i}^{′} ( f ) = [ \begin{matrix}{g}_{1} ( {doa}_{i} ( f ) ) \\ ⋮ \\ {g}_{N} ( {doa}_{i} ( f ) )\end{matrix} ] \qquad [ Numerical equation 9 ]$$

Where gᵢ(x) is a function for converting an arrival direction x into resynthesis information, and is a function to be specified channel by channel responding to a configuration of the channel of the multichannel input signal. The conversion function gᵢ(x) could be a linear function, and could be non-linear function.

As a rule, the output of the conversion function gᵢ(x) is a complex numerical value. The conversion function becomes a function for deciding both of the phase term and the amplitude term of the resynthesis information UE'(f), or one of them, dependent upon the arrival direction. The conversion function gᵢ(x) may be decided based upon an auditory feature of a human being. For example, it is well known that as an auditory feature of a human being, a human being recognizes the arrival direction of the sound source by mainly employing a phase difference of the signal for signals of the low-frequency band, and the arrival direction of the sound source by mainly employing an amplitude difference of the signal for signals of the high-frequency band. Upon utilizing this feature, it follows that the conversion function is a function for mainly deciding the phase term of the resynthesis information UE′(f) of the low-frequency band according to the arrival direction of the sound source. On the other hand, the conversion function becomes a function for mainly deciding the amplitude term of the resynthesis information UE′(f) in the high-frequency band according to the arrival direction of the sound source. Additionally, the conversion function could be a function for arbitrarily deciding the amplitude term and the phase term according to the arrival direction of the sound source without depending upon the above-mentioned auditory feature.

This conversion function is equivalent to shaping the resynthesis information outputted by the resynthesis information conversion unit 321 according to the arrival direction in order to enhance the coding efficiency, or in order to enhancing a stability of each sound source in the receiving unit. For example, when the output of the conversion function is represented only by the amplitude term, the conversion function is equivalent to a function for representing the phase term being included in the resynthesis information with the amplitude term so as to compensate an influence upon the arrival direction by the phase term being included in the resynthesis information outputted by the resynthesis information conversion unit 321 with the amplitude term of the regenerated resynthesis information. In this case, an output of the conversion function becomes a real numerical value. On the other hand, when an output of the conversion function gᵢ(x) is represented only by the phase term, the conversion function is equivalent to a function for representing the amplitude term being included in the resynthesis information with the phase term so as to compensate an influence upon the arrival direction by the amplitude term being included in the resynthesis information outputted by the resynthesis information conversion unit 321 with the phase term of the regenerated resynthesis information. In this case, magnitude of the output of the conversion function becomes one (1). Further, the conversion function gᵢ(x) can be also configured as a head related transfer function. Employing the head related transfer function corresponding to the arrival direction makes it possible to quasi-convert the arrival direction of the sound source into the resynthesis information. In this case, an output of the conversion function gᵢ(x) becomes a complex numerical value.

Another operational example of the resynthesis information shaping unit 501 will be explained in details. This operational example is characterized in shaping the resynthesis information without estimating the arrival direction. The resynthesis information shaping unit 501 can shape the resynthesis information outputted by the resynthesis information conversion unit 321 according to a predetermined function. For example, the resynthesis information shaping unit 501 can generate the shaped resynthesis information by employing a predetermined shaping function having the amplitude term and the phase term being included in the resynthesis information as an input. At this time, when an output of the shaping function is represented only by the amplitude term, the shaping function becomes a function for representing the phase term of the resynthesis information with the amplitude term so as to compensate an influence upon the localization of the sound source signal by the amplitude term being included in the resynthesis information with the phase term of the shaped resynthesis information. In this case, an output of the shaping function becomes a real numerical value. On the other hand, when an output of the shaping function is represented only by the phase term, the shaping function becomes a function for representing the amplitude term of the resynthesis information with the phase term so as to compensate an influence upon the localization of the sound source signal by the amplitude term being included in the resynthesis information with the phase term of the shaped resynthesis information. In this case, magnitude of an output of the shaping function becomes one (1). Needless to say, the shaping function could be a function for arbitrarily deciding the amplitude term and the phase term. In addition, the resynthesis information can be shaped based upon the auditory feature of a human being such as the masking effect. For example, an output of the shaping function in the frequency band in which the recognition by a human being is impossible due to the masking effect can be set as 0 (zero). While the method of calculating the resynthesis information for each frequency component was exemplified in the foregoing explanation of the shaping function, after collecting the resynthesis information of a plurality of the frequency bands, the resynthesis information may be calculated.

Additionally, as described before, the resynthesis information represents a relation between a plurality of the sound source signals and the multichannel input signal, namely the localization information, whereby an arrangement position of the microphones having collected and recorded the multichannel input signals greatly takes part in it. For example, when the microphones are arranged adjacently to each other, the resynthesis information outputted by the resynthesis information conversion unit 321 represents the localization information of the sound source signal for the adjacently arranged microphones. For this, even though a human being hears the signal resynthesized by employing the resynthesis information for the adjacently arranged microphones, it is difficult to obtain the stability thereof. Also in such a case, employing the foregoing method makes it possible to generate the resynthesis information that allows the stability to be recognized auditorily. Further, when the number of the channels of the output signal and the arrangement position of the loudspeakers in the case of outputting the output signal from the loudspeaker are already known to the receiving unit, the resynthesis information may be generated by employing the foregoing methods so that a human being auditorily grasps the stability at the moment of hearing the signal resynthesized in the receiving unit. Also when the number of the output channels and the arrangement position of the loudspeakers are not known, a plurality of pieces of the resynthesis information may be generated by supposing the number of the output channels and the arrangement positions of the loudspeakers previously decided in a plural number.

Next, now returning to FIG. 6, a configuration example of the signal separation unit 101 will be explained in details. The signal separation unit 101 receives the multichannel input signal and the separation information, and generates the separated signal by separating the multichannel input signal into respective sound source signals based upon the separation information. And, the signal separation unit 101 outputs the separated signal to the encoding unit 510. At first, the signal separation unit 101 performs the frequency conversion for the multichannel input signal. A method of performing the frequency conversion is similar to the method of the frequency conversion explained in the separation information calculation unit 102 of the first embodiment, so its explanation is omitted. Upon defining the frequency component of the multichannel input signal in the frequency band f as X(f) and the frequency component of the separation information as W(f), the frequency component Y(f) of the separated signal behaves like Y(f)=W(f)×(f). Continuously, the signal separation unit 101 performs the inverse frequency conversion for the frequency component of the separated signal. A method of performing the inverse frequency conversion is similar to the method of the inverse frequency conversion explained in the decoding unit 320 of the first embodiment, so its explanation is omitted. And, the signal separation unit 101 outputs the signal subjected to the inverse frequency conversion as the separated signal.

Another operational example of the signal separation unit 101 will be explained. At first, the signal separation unit 101 performs the inverse frequency conversion for the separation information, and generates the impulse response (filter coefficient). A method of the inverse frequency conversion is similar to the method of the inverse frequency conversion explained in the decoding unit 320 of the first embodiment, so its explanation is omitted. And, the signal separation unit 101 generates the separated signal by convoluting the multichannel input signal with the impulse response.

Continuously, a configuration example of the encoding unit 510 will be explained in details. The encoding unit 510 receives the separated signal and the resynthesis information, and generates the encoded separated signal and the encoded resynthesis information as the transmission signal by encoding the separated signal and the resynthesis information. And, the encoding unit 510 outputs the transmission signal to the transmission path.

At first, a specific example of encoding the separated signal will be explained. The encoding unit 510 generates the encoded separated signal by encoding the separated signal. As a method of encoding the separated signal, a process similar to the process of encoding the multichannel input signal explained in the encoding unit 300 of the first embodiment may be employed, so its explanation is omitted.

Continuously, a specific example of encoding the resynthesis information will be explained. The encoding unit 510 generates the encoded resynthesis information by encoding the resynthesis information. As a method of encoding the resynthesis information, a process similar to the process of encoding the separation information explained in the encoding unit 300 of the first embodiment may be employed, so its explanation is omitted.

Next, a configuration example of the decoding unit 520 will be explained in details. The decoding unit 520 decodes the received transmission signal into the decoded separated signal and the decoded resynthesis information. The decoding unit 520 outputs the decoded separated signal to the resynthesis unit 530, and the decoded resynthesis information to the resynthesis information integration unit 322, respectively.

At first, a specific example of decoding the encoded separated signal will be explained. The decoding unit 520 generates the decoded separated signal by decoding the encoded separated signal. A decoding method corresponding to the encoding method of the separated signal employed by the encoding method 510 is employed for decoding the encoded separated signal. As a process of decoding the encoded separated signal, a process similar to the process of decoding the encoded multichannel input signal explained in the decoding unit 310 of the first embodiment may be employed, so its explanation is omitted.

Continuously, a specific example of decoding the encoded resynthesis information will be explained. The decoding unit 520 generates the decoded resynthesis information by decoding the encoded resynthesis information. A decoding method corresponding to the encoding method of the resynthesis information employed by the encoding unit 410 is employed for decoding the encoded resynthesis information. As a process of decoding the encoded resynthesis information, a process similar to the process of decoding the separation information explained in the decoding unit 310 of the first embodiment may be employed, so its explanation is omitted.

The resynthesis information integration unit 322 generates the integrated resynthesis information by integrating the received output signal information and decoded resynthesis information. The resynthesis information integration unit 322 is one explained by employing FIG. 2 in the first embodiment, so its explanation is omitted. Additionally, when pieces of the resynthesis information are present in a plural number, one piece, out of a plurality of the pieces of the resynthesis information, is selected, and employed. As a method of selection, a human being in the receiving side may select the resynthesis information, and the resynthesis information may be automatically selected responding to the number of the channels of the output signal and an arrangement position of the loudspeakers.

Next, a configuration example of the signal resynthesis unit 530 will be explained in details. The signal resynthesis unit 530 receives the decoded separated signal and the integrated resynthesis information, and generates the multichannel output signal by independently modifying a plurality of the sound source signals constituting the decoded separated signal based upon the integrated resynthesis information. The signal resynthesis unit 530 outputs the multichannel output signal.

Hereinafter, an operational example of the signal resynthesis unit 530 will be explained. At first, the signal resynthesis unit 530 performs the frequency conversion for the decoded separated signal. A method of performing the frequency conversion is similar to the method of the frequency conversion explained in the encoding unit 300 of the first embodiment, so its explanation is omitted. Upon defining the frequency component of the decoded separate signal in the frequency band f as YDᵢ(f), i=1, 2, . . . , P (P is the number of the sound source signals), and the frequency component of the integrated resynthesis information as UC(f), the frequency component Zᵢ(f) i=1, 2, . . . , N (N is the number of the output channels) of the controlled signal behaves like the following equation.

$$[ \begin{matrix}{Z}_{1} ( f ) \\ {Z}_{2} ( f ) \\ ⋮ \\ {Z}_{N} ( f )\end{matrix} ] = UC ( f ) \cdot [ \begin{matrix}{YD}_{1} ( f ) \\ {YD}_{2} ( f ) \\ ⋮ \\ {YD}_{P} ( f )\end{matrix} ] \qquad [ Numerical equation 10 ]$$

UC(f) is a matrix with N rows and P columns. Continuously, the signal resynthesis unit 530 performs the inverse frequency conversion for the frequency component of the controlled signal. A method of performing the inverse frequency conversion is similar to the method of inverse frequency conversion explained in the decoding unit 310 of the first embodiment, so its explanation is omitted. And, the signal resynthesis unit 530 outputs the signal subjected to the inverse frequency conversion as the multichannel output signal.

Another operational example of the signal resynthesis unit 530 will be explained. At first, the signal resynthesis unit 530 performs the inverse frequency conversion for the integrated resynthesis information, and generates the impulse response (filter coefficient). A method of performing the inverse frequency conversion is similar to the method of the inverse frequency conversion explained in the decoding unit 310 of the first embodiment, so its explanation is omitted. And, the signal resynthesis unit 530 generates the multichannel output signal by convoluting the decoded separated signal with the impulse response.

As explained above, the third embodiment of the present invention enables the receiving unit to take a control for each sound source signal based upon the output signal information, and the resynthesis information to be outputted from the transmission unit. That is, the third embodiment enables the receiving unit to localize a desired sound source signal in a desired position, and to suppress or emphasize it. Further, the multichannel output signal subjected to the localization identical to that of the multichannel input signal received in the transmission unit can be easily reproduced in the receiving unit because the resynthesis information including the localization information of each sound source signal constituting the multichannel input signal received by the transmission unit is transmitted. In addition, in the third embodiment, there is no necessity for the conversion into the decoded resynthesis information in the receiving unit because the resynthesis information is transmitted, so the arithmetic quantity of the receiving unit can be curtailed, which is different from the first embodiment. Additionally, the resynthesis information is efficiently quantized as compared with the case of quantizing the separation information because the resynthesis information can be shaped so as to represent only the localization information of each sound source signal, thereby enabling the information quantity of the transmission signal to be curtailed. In addition, the resynthesis information can be employed as an initial value of the output signal information, and the user can input the output signal information responding to its own taste after hearing the multichannel output signal generated based upon the resynthesis information when the output signal information cannot be obtained at the time of starting the generation of the multichannel output signal, for example, at the time of switching in the power source because the resynthesis information represents the localization information of each sound source signal. For this, the output signal information does not need to be inputted sound source by sound source from the beginning, and convenience of the user is enhanced.

### Fourth Embodiment

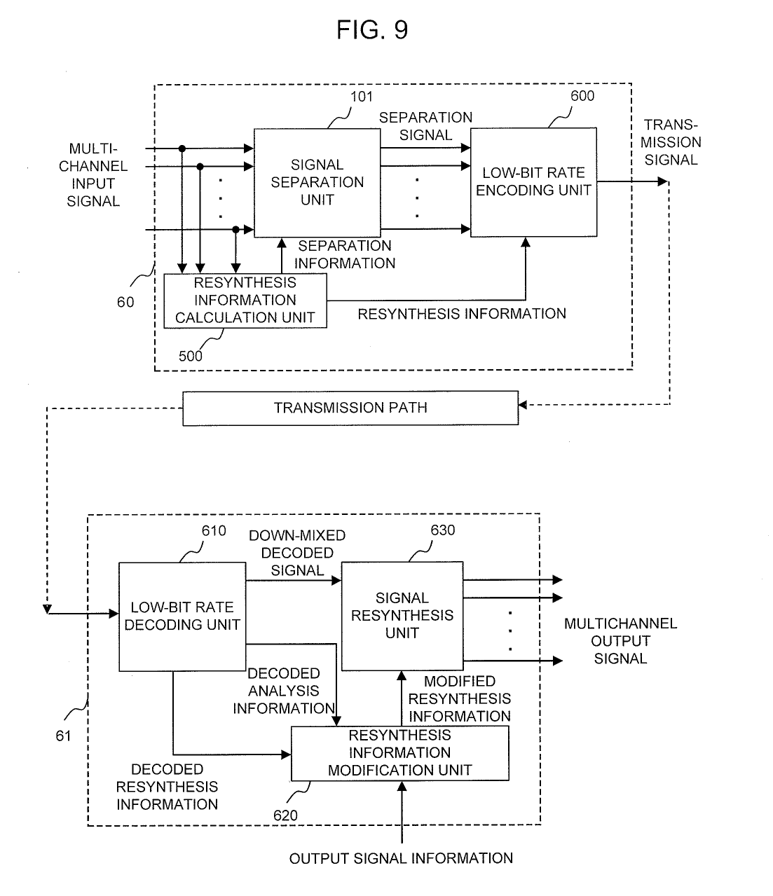

A fourth embodiment of the present invention will be explained by making a reference to FIG. 9. The fourth embodiment assumes a configuration in which a transmission unit 60 and a receiving unit 61 are connected via the transmission path. The transmission unit 60 receives the multichannel input signal having a plurality of the sound source signals mixed therein, and outputs the transmission signal. The transmission signal is inputted into the receiving unit 61 via the transmission path. The receiving unit 61 receives the transmission signal and the output signal information, and outputs the multichannel output signal.

The transmission unit 60 receives the multichannel input signal having a plurality of the sound source signals mixed therein, and outputs the transmission signal. The transmission unit 60 is configured of a resynthesis information calculation unit 500, a signal separation unit 101, and a low-bit rate encoding unit 600. The multichannel input signal is inputted into the resynthesis information calculation unit 500 and the signal separation unit 101. The resynthesized information calculation unit 500 generates the separation information for separating the multichannel input signal into a plurality of the sound source signals, and the resynthesis information representing a relation between a plurality of the sound source signals constituting the multichannel input signal and the multichannel input signal. And, the resynthesis information calculation unit 500 outputs the separation information to the signal separation unit 101, and the resynthesis information to the low-bit rate encoding unit 600, respectively. The signal separation unit 101 receives the multichannel input signal and the separation information, and generates the separated signal by separating the multichannel input signal. And, the signal separation unit 101 outputs the separated signal to the low-bit rate encoding unit 600. The low-bit rate encoding unit 600 generates the transmission signal by encoding the separated signal received from the signal separation unit 101, and the resynthesis information received from the synthesis information calculation unit 500. And, the low-bit rate encoding unit 600 outputs the transmission signal to the transmission path. The transmission unit 60, as compared with the transmission unit 50 of FIG. 6 representing the third embodiment, differs in a point that the encoding unit 510 is replaced with the low-bit rate encoding unit 600.

The receiving unit 61 receives the transmission signal and the output signal information, and outputs the multichannel output signal. The receiving unit 61 is configured of a low-bit rate decoding unit 610, a resynthesis information modification unit 620, and a signal resynthesis unit 630. The transmission signal is inputted into the low-bit rate decoding unit 610. The output signal information is inputted into the resynthesis information modification unit 620. At first, the low-bit rate decoding unit 610 decodes the received transmission signal into the down-mixed decoded signal, the decoded analysis information, and the decoded resynthesis information. Continuously, the low-bit rate decoding unit 610 outputs the down-mixed decoded signal to the signal resynthesis unit 630, and the decoded analysis information and the decoded resynthesis information to the resynthesis information modification unit 620, respectively. The resynthesis information modification unit 620 generates the modified resynthesis information by integrating the output signal information, and the decoded analysis information and decoded resynthesis information received from the low-bit rate decoding unit 610. And, the resynthesis information modification unit 620 outputs the modified resynthesis information to the signal resynthesis unit 630. The signal resynthesis unit 630 resynthesizes the multichannel output signal by modifying the down-mixed decoded signal received from the low-bit rate decoding unit 610 based upon the modified resynthesis information received from the resynthesis information modification unit 620. And, The signal resynthesis unit 630 outputs the multichannel output signal. The receiving unit 61, as compared with the receiving unit 51 of FIG. 6 representing the third embodiment, differs in a point that the decoding unit 520, the resynthesis information integration unit 322, and the signal resynthesis unit 530 are replaced with the low-bit rate decoding unit 610, the resynthesis information modification unit 620, and the signal resynthesis unit 630, respectively.

The resynthesis information is information representing a relation between a plurality of the sound source signals to be included in the multichannel input signal, and the multichannel input signal, as explained in the third embodiment. Further, the output signal information is one already explained in the first embodiment. Additionally, as explained in the third embodiment, the user can input the output signal information of this embodiment responding to its own taste after hearing the multichannel output signal generated based upon the transmitted resynthesis information.

Hereinafter, explanation of a part in which the fourth embodiment overlaps the third embodiment is omitted, and a configuration example of the low-bit rate encoding unit 600, the low-bit rate decoding unit 610, the resynthesis information modification unit 620, and the signal resynthesis unit 630 that are characteristic of this embodiment will be explained.

The low-bit rate encoding unit 600 receive the separated signal and the resynthesis information, and output the transmission signal to the transmission path. The low-bit rate encoding unit 600 performs a process similar to the process of the low-bit rate encoding unit 400 of FIG. 3 explained in the second embodiment. Herein, the separated signal and the resynthesis information correspond to the multichannel input signal and the separation information, being an input of the low-bit rate encoding unit 400 of the second embodiment, respectively. The low-bit rate encoding unit 600 generates the encoded down-mixed signal, the encoded analysis information, and the encoded resynthesis information as the transmission signal. And, the low-bit rate encoding unit 600 outputs the transmission signal.

The low-bit rate decoding unit 610 decodes the received transmission signal into the down-mixed decoded signal, the decoded analysis information, and the decoded resynthesis information. The low-bit rate decoding unit 610 outputs the down-mixed decoded signal to the signal resynthesis unit 630, and the decoded analysis information and the decoded resynthesis information to the resynthesis information modification unit 620, respectively. The low-bit rate decoding unit 610 performs a process similar to the process of the low-bit rate decoding unit 410 of FIG. 3 explained in the second embodiment. Herein, the decoded resynthesis information corresponds to the decoded separation information, being an output of the low-bit rate decoding unit 410 of the second embodiment.

Next, a configuration example of the resynthesis information modification unit 620 of FIG. 9 will be explained in details by making a reference to FIG. 10. The resynthesis information modification unit 620 receives the decoded analysis information, the decoded resynthesis information, and the output signal information, and outputs the modified resynthesis information. The resynthesis information modification unit 620 is configured of a resynthesis information integration unit 322 and a modification unit 621. The decoded analysis information is inputted into the modification unit 621, and the decoded resynthesis information and the output signal information are inputted into the resynthesis information integration unit 322. The resynthesis information integration unit 322 generates the integrated resynthesis information by integrating the received decoded resynthesis information and resynthesis information. The resynthesis information integration unit 322 is one already explained in the first embodiment, so its explanation is omitted.

The modification 621 receives the integrated resynthesis information and the decoded analysis information, and outputs the modified resynthesis information by modifying the integrated resynthesis information based upon the decoded analysis information. The modified resynthesis information represents information for decoding the down-mixed signal into separated signals, and taking a control for each sound source signal. Upon defining the frequency component of the decoded analysis information in the frequency band f as A(f), and the frequency component of the integrated resynthesis information as UC(f), respectively, the frequency component UCA(f) of the modified resynthesis information behaves like UCA(f)=UC(f)×A(f). Herein, upon defining the number of the channels of the down-mixed signal, the sound source signals, and the multichannel output signal as Q, P, and N, respectively, it follows that A(f) and UC(f) are a matrix with P rows and Q columns and a matrix with N rows and P columns, respectively, and UCA(f) is a matrix with N rows and Q columns.

Next, now returning to FIG. 9, a configuration example of the signal resynthesis unit 630 will be explained in details. The signal resynthesis unit 630 receives the down-mixed decoded signal and the modified resynthesis information, and generates the multichannel output signal by modifying the down-mixed decoded signal based upon the modified resynthesis information. The signal resynthesis unit 630 outputs the multichannel output signal.

Hereinafter, an operational example of the signal resynthesis unit 630 will be explained. At first, the signal resynthesis unit 630 performs the frequency conversion for the down-mixed decoded signal. A method of the frequency conversion is similar to the method of the frequency conversion explained in the encoding unit 300 of the first embodiment, so its explanation is omitted. Upon defining the frequency component of the down-mixed decoded signal in the frequency band f as MDᵢ(f), i=1, 2, . . . , Q (Q is the number of the channels of the down-mixed signal), and the frequency component of the modified resynthesis information as UCA(f), respectively, the frequency component Zᵢ(f), i=1, 2, . . . , N (N is the number of the output channels) of the controlled signal behaves like the following equation.

$$[ \begin{matrix}{Z}_{1} ( f ) \\ {Z}_{2} ( f ) \\ ⋮ \\ {Z}_{N} ( f )\end{matrix} ] = UCA ( f ) \cdot [ \begin{matrix}{MD}_{1} ( f ) \\ {MD}_{2} ( f ) \\ ⋮ \\ {MD}_{Q} ( f )\end{matrix} ] \qquad [ Numerical equation 11 ]$$

UCA(f) is a matrix with N rows and Q columns. Continuously, the signal resynthesis unit 630 performs the inverse frequency conversion for the frequency component of the controlled signal. A method of the inverse frequency conversion is similar to the method of the inverse frequency conversion explained in the decoding unit 310 of the first embodiment, so its explanation is omitted. And, the signal resynthesis unit 630 outputs the signal subjected to the inverse frequency conversion as the multichannel output signal.

Another operational example of the signal resynthesis unit 630 will be explained. At first, the signal resynthesis unit 630 performs the inverse frequency conversion for frequency component of the modified resynthesis information, and generates the impulse response (filter coefficient). A method of the inverse frequency conversion is similar to the method of the inverse frequency conversion explained in the decoding unit 310, so its explanation is omitted. And, the signal resynthesis unit 630 can generate the multichannel output signal by convoluting the down-mixed decoded signal with the impulse response.

As explained above, the fourth embodiment of the present invention enables the receiving unit to take a control for each sound source signal based upon the output signal information, and the resynthesis information to be outputted from the transmission unit. That is, the fourth embodiment enables the receiving unit to localize a desired sound source signal in a desired position, and to suppress or emphasize it. Further, the multichannel output signal subjected to the localization identical to that of the multichannel input signal received in the transmission unit can be easily reproduced in the receiving unit because the resynthesis information including the localization information of each sound source signal constituting the multichannel input signal received by the transmission unit is transmitted. In addition, in the fourth embodiment, there is no necessity for the conversion into the decoded resynthesis information in the receiving unit because the resynthesis information is transmitted, so the arithmetic quantity of the receiving unit can be curtailed, which is different from the first embodiment. Additionally, the resynthesis information is efficiently quantized as compared with the case of quantizing the separation information because the resynthesis information can be shaped so as to represent only the localization information of each sound source signal, thereby enabling the information quantity of the transmission signal to be curtailed. In addition, the user can input the output signal information responding to its own taste after hearing the multichannel output signal generated based upon the transmitted resynthesis information because the resynthesis information represents the localization information of each sound source signal. For this, the output signal information does not need to be inputted sound source by sound source from the beginning, and convenience of the user is enhanced. Further, the fourth embodiment, as compared with the third embodiment, enables the information quantity of the transmission signal to be curtailed because the multichannel input signal is encoded with a smaller information quantity.

### Fifth Embodiment

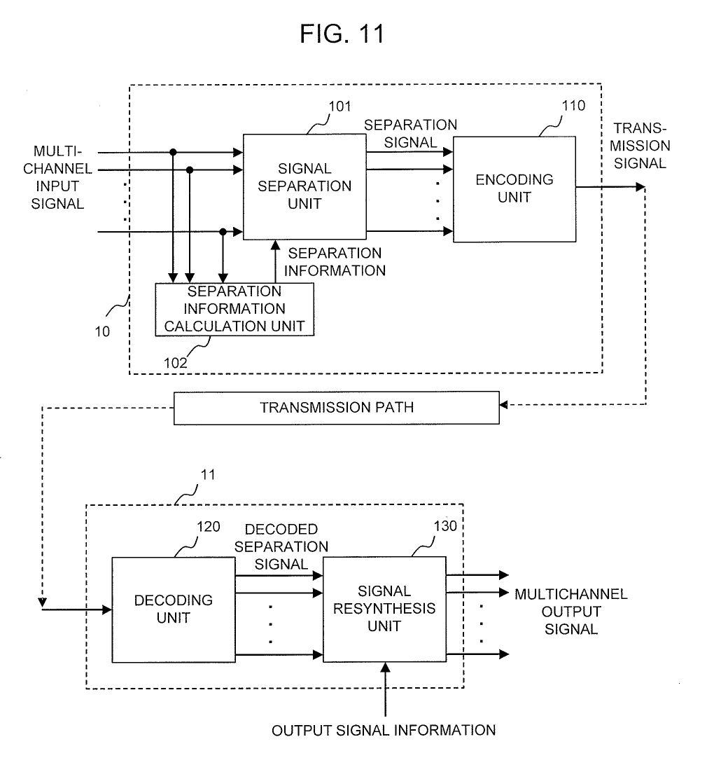

A fifth embodiment of the present invention will be explained by making a reference to FIG. 11. The fifth embodiment assumes a configuration in which a transmission unit 10 and a receiving unit 11 are connected via the transmission path. The transmission unit 10 receives the multichannel input signal having a plurality of the sound source signals mixed therein, and outputs the transmission signal. The transmission signal is inputted into the receiving unit 11 via the transmission path. The receiving unit 11 receives the transmission signal and the output signal information, and outputs the multichannel output signal.

The transmission unit 10 receives the multichannel input signal having a plurality of the sound source signals mixed therein, and outputs the transmission signal. The transmission unit 10 is configured of a separation information calculation unit 102, a signal separation unit 101, and an encoding unit 110. The multichannel input signal is inputted into the separation information calculation unit 102 and the signal separation unit 101. The separation information calculation unit 102 generates the separation information for separating the multichannel input signal into a plurality of the sound source signals by analyzing the multichannel input signal.

And, the separation information calculation unit 102 outputs the separation information to the signal separation unit 101. The signal separation unit 101 receives the multichannel input signal and the separation information, and generates the separated signal by separating the multichannel input signal into respective sound source signals. And, the signal separation unit 101 outputs the separated signal to the encoding unit 110. The encoding unit 110 generates the transmission signal by encoding the separated signal received from the signal separation unit 101. And, the encoding unit 110 outputs the transmission signal to the transmission path. The transmission unit 10, as compared with the transmission unit 30 of FIG. 1 representing the first embodiment, differs in a point that the encoding unit 300 is replaced with the encoding unit 110, and a point of newly including the signal separation unit 101. The signal separation unit 101 is one already explained in the third embodiment.

The encoding unit 110 receives the separated signal, and generates the encoded separated signal by encoding the separated signal. And, the encoding unit 110 outputs the encoded separated signal as the transmission signal. A process of encoding the separated signal is one already explained in the encoding unit 510 of the third embodiment, so its explanation is omitted.

The receiving unit 11 receives the transmission signal and the output signal information, and outputs the multichannel output signal. The receiving unit 11 is configured of a decoding unit 120 and a signal resynthesis unit 130. The transmission signal is inputted into the decoding unit 120. The output signal information is inputted into the signal resynthesis unit 130. At first, the decoding unit 120 decodes the received transmission signal into the decoded separated signal. Continuously, the decoding unit 120 outputs the decoded separated signal to the signal resynthesis unit 130. The signal resynthesis unit 130 resynthesizes the multichannel output signal by modifying the decoded separated signal received from the decoding unit 120 based upon the output signal information. The signal resynthesis unit 130 outputs the multichannel output signal. The receiving unit 11, as compared with the receiving unit 31 of FIG. 1 representing the first embodiment, differs in a point that the decoding unit 310 and the signal resynthesis unit 330 are replaced with the decoding unit 120 and the signal resynthesis unit 130, respectively, and a point of not including the separation/resynthesis information generation unit 320.

The decoding unit 120 decodes the received transmission signal into the decoded separated signal. And, the decoding unit 120 outputs the decoded separated signal to the signal resynthesis unit 130. The decoding of the encoded separated signal is one already explained in the decoding unit 520 of the third embodiment, so its explanation is omitted.

The signal resynthesis unit 130 receives the decoded separated signal and the output signal information, and generates the multichannel output signal by independently modifying a plurality of the sound source signals constituting the decoded separated signal based upon the output signal information. The signal resynthesis unit 130 outputs the multichannel output signal.

Hereinafter, an operational example of the signal resynthesis unit 130 will be explained. At first, the signal resynthesis unit 130 performs the frequency conversion for the decoded separated signal. The method of the frequency conversion is one already explained in the encoding unit 510 of the third embodiment, so its explanation is omitted. Upon defining the frequency component of the decoded separated signal in the frequency band f as YDᵢ(f), i=1, 2, . . . , P (P is the number of the sound source signals), and the frequency component of the output signal information as U(f), respectively, the frequency component Zᵢ(f), i=1, 2, . . . , N (n is the number of the output channels) of the controlled signal behaves like the following equation.

$$[ \begin{matrix}{Z}_{1} ( f ) \\ {Z}_{2} ( f ) \\ ⋮ \\ {Z}_{N} ( f )\end{matrix} ] = U ( f ) \cdot [ \begin{matrix}{YD}_{1} ( f ) \\ {YD}_{2} ( f ) \\ ⋮ \\ {YD}_{P} ( f )\end{matrix} ] \qquad [ Numerical equation 12 ]$$

U(f) is a matrix with N rows and P columns. Continuously, the signal resynthesis unit 130 performs the inverse frequency conversion for the frequency component of the controlled signal. A method of the inverse frequency conversion is similar to the method of the inverse frequency conversion explained in the decoding unit 310 of the first embodiment, so its explanation is omitted. And, the signal resynthesis unit 130 outputs the signal subjected to the inverse frequency conversion as the multichannel output signal.

Another operational example of the signal resynthesis unit 130 will be explained. At first, the signal resynthesis unit 130 performs the inverse frequency conversion for the frequency component of the output signal information, and generates the impulse response (filter coefficient). A method of the inverse frequency conversion is similar to the method of the inverse frequency conversion explained in the decoding unit 310 of the first embodiment, so its explanation is omitted. And, the signal resynthesis unit 130 generates the multichannel output signal by convoluting the decoded separated signal with the impulse response.

As explained above, the fifth embodiment of the present invention enables the receiving unit to take a control for each sound source signal based upon the output signal information. That is, the fifth embodiment enables the receiving unit to localize a desired sound source signal in a desired position, and to suppress or emphasize it. Further, the fifth embodiment, as compared with the first embodiment to the fourth embodiment, enables the information quantity of the transmission signal to be curtailed because the separation information or the resynthesis information is not transmitted. Further, the fifth embodiment, as compared with the first embodiment to the fourth embodiment, enables the process of the receiving unit to be simplified and enables the arithmetic quality of the receiving unit to be curtailed because the separation information or the resynthesis information is not transmitted, so the process of integrating the separation information or the resynthesis information and the output signal information is not performed in the receiving side.

### Sixth Embodiment

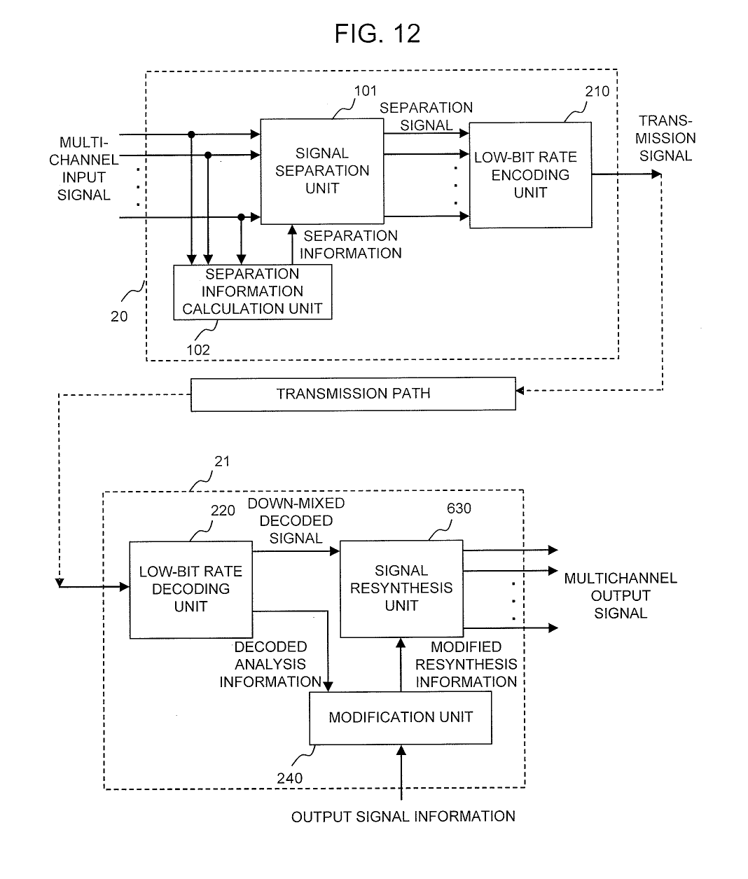

A sixth embodiment of the present invention will be explained by making a reference to FIG. 12. The sixth embodiment assumes a configuration in which a transmission unit 20 and a receiving unit 21 are connected via the transmission path. The transmission unit 20 receives the multichannel input signal having a plurality of the sound source signals mixed therein, and outputs the transmission signal. The transmission signal is inputted into the receiving unit 21 via the transmission path. The receiving unit 12 receives the transmission signal and the output signal information, and outputs the multichannel output signal.

The transmission unit 20 receives the multichannel input signal having a plurality of the sound source signals mixed therein, and outputs the transmission signal. The transmission unit 20 is configured of a separation information calculation unit 102, a signal separation unit 101, and a low-bit rate encoding unit 210. The multichannel input signal is inputted into the separation information calculation unit 102 and the signal separation unit 101. The separation information calculation unit 102 generates the separation information for separating the multichannel input signal into a plurality of the sound source signals by analyzing the multichannel input signal. And, the separation information calculation unit 102 outputs the separation information to the signal separation unit 101. The signal separation unit 101 receives the multichannel input signal and the separation information, and generates the separated signal by separating the multichannel input signal into respective sound source signals. And, the signal separation unit 101 outputs the separated signal to the low-bit rate encoding unit 210. The low-bit rate encoding unit 210 generates the transmission signal by encoding the separated signal received from the signal separation unit 101. And, the low-bit rate encoding unit 210 outputs the transmission signal to the transmission path. The transmission unit 10, as compared with the transmission unit 10 of FIG. 11 representing the fifth embodiment, differs in a point that the encoding unit 110 is replaced with the low-bit rate encoding unit 210.

The receiving unit 12 receives the transmission signal and the output signal information, and outputs the multichannel output signal. The receiving unit 21 is configured of a low-bit rate decoding unit 220, a modification unit 240, and a signal resynthesis unit 630. The transmission signal is inputted into the low-bit rate decoding unit 220. The output signal information is inputted into the modification unit 240. At first, the low-bit rate decoding unit 220 decodes the received transmission signal into the down-mixed decoded signal and the decoded analysis information. Continuously, the low-bit rate decoding unit 220 outputs the down-mixed decoded signal to the signal resynthesis unit 630, and the decoded analysis information to the modification unit 240, respectively. The modification unit 240 generates the modified resynthesis information by modifying the output signal information based upon the decoded analysis information. And, the modification unit 240 outputs the modified resynthesis information to the signal resynthesis unit 230. The signal resynthesis unit 630 resynthesizes the multichannel output signal by modifying the down-mixed decoded signal received from the low-bit rate decoding unit 220 based upon the modified resynthesis information. The signal resynthesis unit 630 outputs the multichannel output signal. The receiving unit 21, as compared with the receiving unit 11 of FIG. 11 representing the fifth embodiment, differs in a point that the decoding unit 120 and the signal resynthesis unit 130 are replaced with the low-bit rate decoding unit 220 and the signal resynthesis unit 630, respectively, and a point of newly including the modification unit 240. The signal resynthesis unit 630 is one already explained in the fourth embodiment.

Hereinafter, explanation of a part in which the sixth embodiment overlaps the fifth embodiment is omitted, and a configuration example of the low-bit rate encoding unit 210, the low-bit rate decoding unit 220, and the modification unit 240, each of which is characteristic of this embodiment, will be explained.

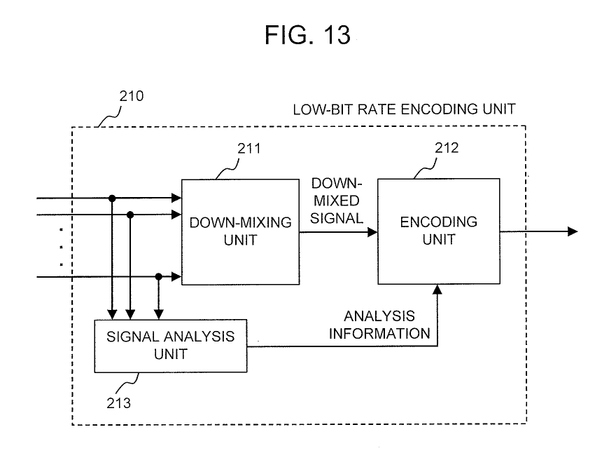

A configuration example of the low-bit rate encoding unit 210 of FIG. 12 will be explained in details by making a reference to FIG. 13. The low-bit rate encoding unit 210 receives the separated signal and outputs the transmission signal to the transmission path. The low-bit rate encoding unit 210 is configured of a down-mixing unit 211, a signal analysis unit 213, and an encoding unit 212. The separated signal is inputted into the signal analysis unit 213 and the down-mixing unit 211. The down-mixing unit 211 generates the down-mixed signal by down-mixing the separated signals. The signal analysis unit 213 generates the analysis information by analyzing the separated signals. The down-mixing unit 211 and the signal analysis unit 213 are ones already explained by employing FIG. 4 in the second embodiment, so its explanation is omitted. The encoding unit 212 generates the encoded down-mixed signal and the encoded analysis information as the transmission signal by encoding the received down-mixed signal and analysis information. The encoding of the down-mixed signal is one already explained in the second embodiment, so its explanation is omitted. Further, the encoding of the analysis information is also one already explained in the second embodiment, so its explanation is omitted. And the encoding unit 212 outputs the transmission signal to the transmission path.

Next, now returning to FIG. 12, a configuration example of the low-bit rate decoding unit 220 will be explained in details. The low-bit rate decoding unit 220 decodes the received transmission signal into the down-mixed decoded signal and decoded analysis information. The decoding of the encoded down-mixed signal is one already explained in the second embodiment, so its explanation is omitted. Further, the decoding of the encoded analysis information is also one already explained in the second embodiment, so its explanation is omitted. And, the low-bit rate decoding unit 220 outputs the down-mixed decoded signal to the signal resynthesis unit 230, and the decoded analysis information to the modification unit 240, respectively.

The modification unit 240 receives the output signal information and the decoded analysis information, and generates the modified resynthesis information by modifying the output signal information based upon the decoded analysis information. And, the modification unit 240 outputs the modified resynthesis information. The modified resynthesis information represents information for decoding the down-mixed decoded signal into the separated signal, and taking a control for each sound source signal. Upon defining the frequency component of the decoded analysis information in the frequency band f as A(f), and the frequency component of the output signal information as U(f), the frequency component UCA(f) of the modified resynthesis information behaves like UCA(f)=U(f)×A(f). Herein, upon defining the number of the channels of the down-mixed signal, the sound source signals, and the multichannel output signal as Q, P, and N, respectively, it follows that A(f) and U(f) are a matrix with P rows and Q columns and a matrix with N rows and P columns, respectively, and UCA(f) is a matrix with N rows and Q columns.

As explained above, the sixth embodiment of the present invention enables the receiving unit to take a control for each sound source signal based upon the output signal information. That is, the sixth embodiment enables the receiving unit to localize a desired sound source signal in a desired position, and to suppress or emphasize it. Further, the sixth embodiment, as compared with the first embodiment to the fourth embodiment, enables the information quantity of the transmission signal to be curtailed because the separation information or the resynthesis information is not transmitted. Further, the sixth embodiment, as compared with the first embodiment to the fourth embodiment, enables the process of the receiving unit to be simplified and enables the arithmetic quality of the receiving unit to be curtailed because the separation information or the resynthesis information is not transmitted, so the process of integrating the separation information or the resynthesis information and the output signal information is not performed in the receiving side. Further, sixth embodiment, as compared with the fifth embodiment, enables the information quantity of the transmission signal to be curtailed because the multichannel input signal is encoded with a smaller information quantity.

### Seventh Embodiment

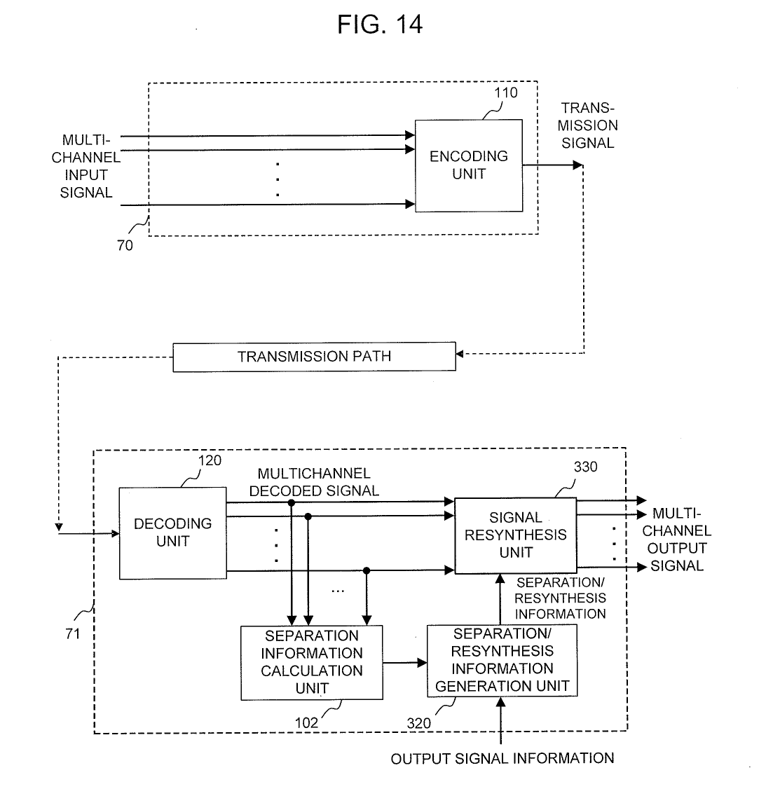

A seventh embodiment of the present invention will be explained by making a reference to FIG. 14. The seventh embodiment assumes a configuration in which a transmission unit 70 and a receiving unit 71 are connected via the transmission path. The transmission unit 70 receives the multichannel input signal having a plurality of the sound source signals mixed therein, and outputs the transmission signal. The transmission signal is inputted into the receiving unit 71 via the transmission path. The receiving unit 71 receives the transmission signal and the output signal information, and outputs the multichannel output signal.

The transmission unit 70 receives the multichannel input signal having a plurality of the sound source signals mixed therein, and outputs the transmission signal. The transmission unit 70 is configured of an encoding unit 110. The multichannel input signal is inputted into the encoding unit 110. The encoding unit 110 generates the transmission signal by encoding the multichannel input signal. And, the encoding unit 110 outputs the transmission signal to the transmission path. A process of encoding the multichannel input signal is one already explained in the encoding unit 300 of the first embodiment, so its explanation is omitted.

The receiving unit 71 receives the transmission signal and the output signal information, and outputs the multichannel output signal. The receiving unit 71 is configured of a decoding unit 120, a separation information calculation unit 102, a separation/resynthesis information generation unit 320, and a signal resynthesis unit 330. The transmission signal is inputted into the decoding unit 120. The output signal information is inputted into the separation/resynthesis information generation unit 320. At first, the decoding unit 120 decodes the received transmission signal into the multichannel decoded signal. Continuously, the decoding unit 120 outputs the multichannel decoded signal to the separation information calculation unit 102 and the signal resynthesis unit 330. The separation information calculation unit 102 generates the separation information for separating the multichannel decoded signal into a plurality of the sound source signals. And, the separation information calculation unit 102 outputs the separation information to the separation/resynthesis information generation unit 320. The separation/resynthesis information generation unit 320 generates the separation/resynthesis information by integrating the output signal information, and the separation information received from the separation information calculation unit 102. And, the separation/resynthesis information generation unit 320 outputs the separation/resynthesis information to the signal resynthesis unit 330. The signal resynthesis unit 330 resynthesizes the multichannel output signal by modifying the multichannel decoded signal received from the decoding unit 120 based upon the separation/resynthesis information received from the separation/resynthesis information generation unit 320. The signal resynthesis unit 330 outputs the multichannel output signal. The receiving unit 71, as compared with the receiving unit 31 of FIG. 1 representing the first embodiment, differs in a point that the decoding unit 310 is replaced with the decoding unit 120, and a point of newly including the separation information calculation unit 102.

The decoding unit 120 decodes the received transmission signal into the multichannel decoded signal. And, the decoding unit 120 outputs the multichannel decoded signal to the separation information calculation unit 102 and the signal resynthesis unit 330. The decoding of the encoded multichannel input signal is one already explained in the decoding unit 310 of the first embodiment, so its explanation is omitted.

The separation information calculation unit 102 generates the separation information by analyzing the received multichannel decoded signal. And, the separation information calculation unit 102 outputs the separation information. The separation information, which is information representing a relation between the multichannel decoded signal and the sound source signal, is utilized for separating the multichannel decoded signal into a plurality of the sound source signals. An operation of the separation information calculation unit 102 is one already explained in the first embodiment, so its explanation is omitted.

As explained above, the seventh embodiment of the present invention enables the receiving unit to take a control for each sound source signal based upon the output signal information. That is, the sixth embodiment enables the receiving unit to localize a desired sound source signal in a desired position, and to suppress or emphasize it. Further, the sixth embodiment, as compared with the first embodiment to the fourth embodiment, enables the information quantity of the transmission signal to be curtailed because the separation information or the resynthesis information is not transmitted. Further, the sixth embodiment, as compared with the first embodiment to the fourth embodiment, makes it possible to curtail the arithmetic quality of the transmission unit because the separation information or the resynthesis information is not generated. Further, the sixth embodiment, as compared with the first embodiment to the sixth embodiment, enables the receiving unit to take a control for each sound source signal even though the receiving unit receives only the signal not separated into the sound source signal.

### Eighth Embodiment

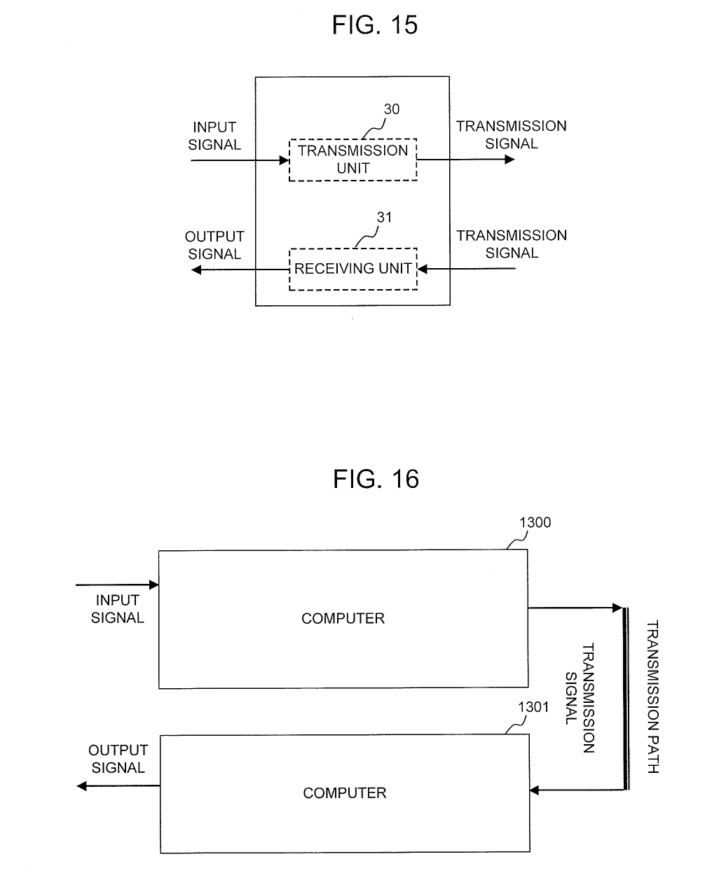

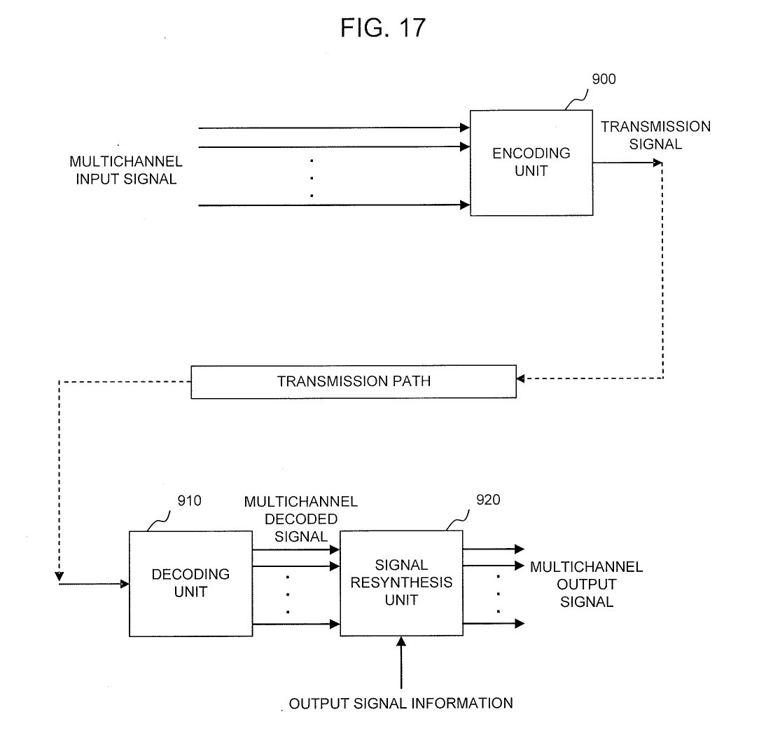

An eighth embodiment of the present invention will be explained by making a reference to FIG. 15. Only one-way communication was taken into consideration in the embodiments ranging from the first embodiment up to the sixth embodiment. That is, the communication between the transmission unit integrally built in a terminal and the receiving unit integrally built in another terminal was explained. In the eighth embodiment, which takes bilateral communication into consideration, both of the transmission unit and the receiving unit for which the present invention has been applied are integrally built in one transmission/reception terminal. In the eighth embodiment of the present invention, incorporating both of the transmission unit and the receiving unit into the terminal yields an effect of the present invention at the moment of utilizing it for the bilateral communication apparatuses such as a television conference terminal and a mobile telephone.

The signal analysis control system of the present invention is applicable in the case that the one-way sound communication is made, for example, in the case of a broadcast. The transmission terminal of a broadcast station may employ any of the transmission units of the first embodiment to the sixth embodiment of the present invention. The so-called broadcast station includes not only a licensed broadcast station but also a point in which sound is transmitted and no reception is almost performed, for example, a main site of a multi-point television conference.

Further, the signal analysis control system of the present invention is applicable to a point as well in which only the reception is performed. Any of the receiving units of the first embodiment to the seventh embodiment of the present invention may be employed for the reception terminal in a point in which only the reception is performed.

### Ninth Embodiment

The signal process apparatus based upon a ninth embodiment of the present invention will be explained in details by making a reference to FIG. 16. The ninth embodiment of the present invention is configured of computers 1300 and 1301 each of which operates under a program control. The computer could be any of a central processing apparatus, a processor, and a data processing apparatus.

The computer 1300, which performs a process related to any of the first embodiment to the sixth embodiment, operates based upon a program for receiving the multichannel input signal and outputting the transmission signal. On the other hand, the computer 1301, which performs a process related to any of the first embodiment to the eighth embodiment, operates based upon a program for receiving the transmission signal and outputting the multichannel output signal. Additionally, in the case of having both of the transmission unit and receiving unit explained in the eighth embodiment, the transmission process and the reception process may be executed by employing the identical computer.

While in the first embodiment to the ninth embodiment explained above, the operations of the transmission unit, the transmission path, and the receiving unit were exemplified, they may be replaced with the recoding unit, the storage medium, and the reproduction unit, respectively. For example, the transmission unit 30 shown in FIG. 1 may output the transmission signal as a bit stream to the storage medium, and record the bit stream into the storage medium. Further, the receiving unit 31 may take out the bit stream recorded into the storage medium, and generate the output signal by decoding the bit stream and performing a process therefor.

The 1st mode of the present invention is characterized in that a signal analysis apparatus comprising a separation information calculation unit for generating separation information for separating an input signal having sound source signals mixed therein into said sound source signals, said signal analysis apparatus sending said input signal and said separation information.

In addition, the 2nd mode of the present invention, in the above-mentioned mode, is characterized in that the signal analysis apparatus comprising an encoding unit for generating encoding information by encoding said input signal and said separation information, said signal analysis apparatus sending said encoding information.

In addition, the 3rd mode of the present invention, in the above-mentioned mode, is characterized in that said encoding unit comprises: a down-mixing unit for generating a down-mixed signal from said input signal; a signal analysis unit for generating analysis information representing a relation between said input signal and said down-mixed signal; and a second encoding unit for generating encoding information by encoding said down-mixed signal, said analysis information, and said separation information.

The 4th mode of the present invention is characterized in that a signal analysis apparatus, comprising: a resynthesis information calculation unit for generating separation information for separating an input signal having sound source signals mixed therein into said sound source signals, and resynthesis information representing a relation between said input signal and said sound source signal; and a signal separation unit for generating separated signal by separating said input signal into said sound source signals based upon said separation information, said signal analysis apparatus sending said separated signal and said resynthesis information.

In addition, the 5th mode of the present invention, in the above-mentioned mode, is characterized in that said resynthesis information calculation unit comprises: a separation information calculation unit for generating said separation information for separating said input signal into said sound source signals; and a resynthesis information conversion unit for generating said resynthesis information representing a relation between said input signal and said sound source signal based upon said separation information.

In addition, the 6th mode of the present invention, in the above-mentioned mode, is characterized in that said resynthesis information calculation unit comprises: a separation information calculation unit for generating said separation information for separating said input signal into said sound source signals; a resynthesis information conversion unit for generating said resynthesis information representing a relation between said input signal and said sound source signal based upon said separation information; and a resynthesis information shaping unit for shaping said resynthesis information.

In addition, the 7th mode of the present invention, in the above-mentioned mode, is characterized in that the signal analysis apparatus comprising an encoding unit for generating encoding information by encoding said separated signal and said resynthesis information, said signal analysis apparatus sending said encoding information.

In addition, the 8th mode of the present invention, in the above-mentioned mode, is characterized in that said encoding unit comprises: a down-mixing unit for generating a down-mixed signal from said separated signal; a signal analysis unit for generating analysis information representing a relation between said input signal and said down-mixed signal from said input signal; and a second encoding unit for generating encoding information by encoding said down-mixed signal, said analysis information, and said resynthesis information.

The 9th mode of the present invention is characterized in that a signal analysis apparatus, comprising: a separation information calculation unit for generating separation information for separating an input signal having sound source signals mixed therein into said sound source signals; a signal separation unit for generating a separated signal by separating said input signal into said sound source signals based upon said separation information; and an encoding unit for encoding said separated signal.

In addition, the 10th mode of the present invention, in the above-mentioned mode, is characterized in that said encoding unit comprises: a down-mixing unit for generating a down-mixed signal from said separated signal; a signal analysis unit for generating analysis information representing a relation between said input signal and said down-mixed signal from said input signal; and a second encoding unit for encoding said down-mixed signal and said analysis information.

The 11th mode of the present invention is characterized in that a signal control apparatus for receiving a mixed signal having sound source signals mixed therein, separation information for separating said mixed signal into said sound source signals, and output signal information for controlling a specific sound source signal, comprising: a separation/resynthesis information generation unit for generating separation/resynthesis information for controlling said sound source signals from said output signal information and said separation information; and a signal resynthesis unit for modifying said mixed signal based upon said separation/resynthesis information.

In addition, the 12th mode of the present invention, in the above-mentioned mode, is characterized in that said separation/resynthesis information generation unit comprises: a resynthesis information conversion unit for generating resynthesis information representing a relation between said mixed signal and said sound source signal from said separation information; a resynthesis information integration unit for generating integrated resynthesis information by integrating said output signal information and said resynthesis information; and a synthesis unit for generating said separation/resynthesis information by synthesizing said integrated resynthesis information and said separation information.

The 13th mode of the present invention is characterized in that a signal control apparatus for receiving a down-mixed signal having a mixed signal down-mixed therein, said mixed signal having sound source signals mixed therein, analysis information representing a relation between said down-mixed signal and said mixed signal, separation information for separating said mixed signal into said sound source signals, and output signal information for controlling a specific sound source signal, comprising: a separation/resynthesis information generation unit for generating modified separation/resynthesis information for controlling said sound source signals from said output signal information, said analysis information, and said separation information; and a signal resynthesis unit for modifying said down-mixed signal based upon said modified separation/resynthesis information.

In addition, the 14th mode of the present invention, in the above-mentioned mode, is characterized in that said separation/resynthesis information generation unit comprises: a resynthesis information conversion unit for generating resynthesis information representing a relation between said mixed signal and said sound source signal from said separation information; a resynthesis information integration unit for generating integrated resynthesis information by integrating said output signal information and said resynthesis information; a synthesis unit for generating separation/resynthesis information by synthesizing said integrated resynthesis information and said separation information; and a modification unit for generating said modified separation/resynthesis information by modifying said separation/resynthesis information based upon said analysis information.

The 15th mode of the present invention is characterized in that a signal control apparatus for receiving a separated signal obtained by separating a mixed signal having sound source signals mixed therein, resynthesis information representing a relation between said mixed signal and said separated signal, and output signal information for controlling a specific sound source signal, comprising: a resynthesis information integration unit for generating integrated resynthesis information for controlling said sound source signals from said output signal information and said resynthesis information; and a signal resynthesis unit for modifying said separated signal based upon said modified separation/resynthesis information.

The 16th mode of the present invention is characterized in that a signal control apparatus for receiving a down-mixed signal having a separated signal down-mixed therein, said separated signal obtained by separating a mixed signal having sound source signals mixed therein, analysis information representing a relation between said down-mixed signal and said separated signal, resynthesis information representing a relation between said mixed signal and said separated signal, and output signal information for controlling a specific sound source signal, comprising: a resynthesis information modification unit for generating modified resynthesis information for controlling said sound source signals from said output signal information, said analysis information, and said resynthesis information; and a signal resynthesis unit for modifying said down-mixed signal based upon said modified resynthesis information.

In addition, the 17th mode of the present invention, in the above-mentioned mode, is characterized in that said resynthesis information modification unit comprises: a resynthesis information integration unit for generating integrated resynthesis information by integrating said output signal information and said resynthesis information; and a modification unit for generating said modified resynthesis information by modifying said integrated resynthesis information based upon said analysis information.

The 18th mode of the present invention is characterized in that a signal control apparatus for receiving a separated signal obtained by separating a mixed signal having sound source signals mixed therein, and output signal information for controlling a specific sound source signal, comprising a signal resynthesis unit for modifying said separated signal based upon said output signal information.

The 19th mode of the present invention is characterized in that a signal control apparatus for receiving a down-mixed signal having a separated signal down-mixed therein, said separated signal obtained by separating a mixed signal having sound source signals mixed therein, analysis information representing a relation between said down-mixed signal and said separated signal, and output signal information for controlling a specific sound source signal, comprising: a resynthesis information modification unit for generating modified resynthesis information for controlling said sound source signals from said output signal information and said analysis information; and a signal resynthesis unit for modifying said down-mixed signal based upon said modified resynthesis information.

The 20th mode of the present invention is characterized in that a signal control apparatus for receiving a mixed signal having sound source signals mixed therein, and output signal information for controlling a specific sound source signal, comprising: a separation information calculation unit for generating separation information for separating said mixed signal into said sound source signals; a separation/resynthesis information generation unit for generating separation/resynthesis information for controlling said sound source signals from said output signal information and said separation information; and a signal resynthesis unit for modifying said mixed signal based upon said separation/resynthesis information.

In addition, the 21st mode of the present invention, in the above-mentioned mode, is characterized in that said separation/resynthesis information generation unit comprises: a resynthesis information conversion unit for generating resynthesis information representing a relation between said mixed signal and said sound source signal from said separation information; a resynthesis information integration unit for generating integrated resynthesis information by integrating said output signal information and said resynthesis information; and a synthesis unit for generating said separation/resynthesis information by synthesizing said integrated resynthesis information and said separation information.

In addition, the 22nd mode of the present invention, in the above-mentioned mode, is characterized in that said signal control apparatus generating said integrated resynthesis information by employing only said resynthesis information.

The 23rd mode of the present invention is characterized in that a signal analysis method, comprising: generating separation information for separating an input signal having sound source signals mixed therein into said sound source signals; and sending said input signal and said separation information.

In addition, the 24th mode of the present invention, in the above-mentioned mode, is characterized in that the signal analysis method comprising: generating encoding information by encoding said input signal and said separation information; and sending said encoding information.

In addition, the 25th mode of the present invention, in the above-mentioned mode, is characterized in that said encoding comprises: generating a down-mixed signal from said input signal; generating analysis information representing a relation between said input signal and said down-mixed signal; and generating encoding information by encoding said down-mixed signal, said analysis information, and said separation information.

The 26th mode of the present invention is characterized in that a signal analysis method, comprising: generating separation information for separating an input signal having sound source signals mixed therein into said sound source signals, and resynthesis information representing a relation between said input signal and said sound source signal; generating a separated signal by separating said input signal into said sound source signals based upon said separation information; and sending said separated signal and said resynthesis information.

In addition, the 27th mode of the present invention, in the above-mentioned mode, is characterized in that the signal analysis method comprising: generating said separation information for separating said input signal into said sound source signals; and generating said resynthesis information based upon said separation information.

In addition, the 28th mode of the present invention, in the above-mentioned mode, is characterized in that the signal analysis method comprising: generating said separation information for separating said input signal into said sound source signals; generating said resynthesis information based upon said separation information; and shaping said resynthesis information.

In addition, the 29th mode of the present invention, in the above-mentioned mode, is characterized in that the signal analysis method comprising: generating encoding information by encoding said separated signal and said resynthesis information; and sending said encoding information.

In addition, the 30th mode of the present invention, in the above-mentioned mode, is characterized in that the signal analysis method comprises: generating a down-mixed signal from said separated signal; generating analysis information representing a relation between said input signal and said down-mixed signal from said input signal; and generating said encoding information by encoding said down-mixed signal, said analysis information, and said resynthesis information.

The 31st mode of the present invention is characterized in that a signal analysis method, comprising: generating separation information for separating an input signal having sound source signals mixed therein into said sound source signals; generating a separated signal by separating said input signal into said sound source signals based upon said separation information; and encoding said separated signal.

In addition, the 32th mode of the present invention, in the above-mentioned mode, is characterized in that the signal analysis method comprising: generating a down-mixed signal from said separated signal; generating analysis information representing a relation between said input signal and said down-mixed signal from said input signal; and encoding said down-mixed signal and said analysis information.

The 33th mode of the present invention is characterized in that a signal control method comprising: receiving a mixed signal having sound source signals mixed therein, separation information for separating said mixed signal into said sound source signals, and output signal information for controlling a specific sound source signal; generating separation/resynthesis information for controlling said sound source signals from said output signal information and said separation information; and modifying said mixed signal based upon said separation/resynthesis information.

In addition, the 34th mode of the present invention, in the above-mentioned mode, is characterized in that the signal control method comprising: generating resynthesis information representing a relation between said mixed signal and said sound source signal from said separation information; generating integrated resynthesis information by integrating said output signal information and said resynthesis information; and generating said separation/resynthesis information by synthesizing said integrated resynthesis information and said separation information.

The 35th mode of the present invention is characterized in that a signal control method, comprising: receiving a down-mixed signal having a mixed signal down-mixed therein, said mixed signal having sound source signals mixed therein, analysis information representing a relation between said down-mixed signal and said mixed signal, separation information for separating said mixed signal into said sound source signals, and output signal information for controlling a specific sound source signal; generating modified separation/resynthesis information for controlling said sound source signals from said output signal information, said analysis information and said separation information; and modifying said down-mixed signal based upon said modified separation/resynthesis information.

In addition, the 36th mode of the present invention, in the above-mentioned mode, is characterized in that the signal control method comprising: generating resynthesis information representing a relation between said mixed signal and said sound source signal from said separation information; generating integrated resynthesis information by integrating said output signal information and said resynthesis information; generating separation/resynthesis information by synthesizing said integrated resynthesis information and said separation information; and generating said modified separation/resynthesis information by modifying said separation/resynthesis information based upon said analysis information.

In addition, the 37th mode of the present invention is characterized in that a signal control method, comprising: receiving a separated signal obtained by separating a mixed signal having sound source signals mixed therein, resynthesis information representing a relation between said mixed signal and said separated signal, and output signal information for controlling a specific sound source signal; generating integrated resynthesis information for controlling said sound source signals from said output signal information and said resynthesis information; and modifying said separated signal based upon said modified separation/resynthesis information.

In addition, the 38th mode of the present invention is characterized in that a signal control method, comprising receiving a down-mixed signal having a separated signal down-mixed therein, said separated signal obtained by separating a mixed signal having sound source signals mixed therein, analysis information representing a relation between said down-mixed signal and said separated signal, resynthesis information representing a relation between said mixed signal and said separated signal, and output signal information for controlling a specific sound source signal; generating modified resynthesis information for controlling said sound source signals from said output signal information, said analysis information, and said resynthesis information; and modifying said down-mixed signal based upon said modified resynthesis information.

In addition, the 39th mode of the present invention, in the above-mentioned mode, is characterized in that the signal control method comprising: generating integrated resynthesis information by integrating said output signal information and said resynthesis information; and generating said modified resynthesis information by modifying said integrated resynthesis information based upon said analysis information.

The 40th mode of the present invention is characterized in that a signal control method, comprising: receiving a separated signal obtained by separating a mixed signal having sound source signals mixed therein, and output signal information for controlling a specific sound source signal; and modifying said separated signal based upon said output signal information.

The 41st mode of the present invention is characterized in that a signal control method, comprising: receiving a down-mixed signal having a separated signal down-mixed therein, said separated signal obtained by separating a mixed signal having sound source signals mixed therein, analysis information representing a relation between said down-mixed signal and said separated signal, and output signal information for controlling a specific sound source signal; generating modified resynthesis information for controlling said sound source signals from said output signal information and said analysis information; and modifying said down-mixed signal based upon said modified resynthesis information.

The 42nd mode of the present invention is characterized in that a signal control method, comprising: receiving a mixed signal having sound source signals mixed therein, and output signal information for controlling a specific sound source signal; generating separation information for separating said mixed signal into said sound source signals; generating separation/resynthesis information for controlling said sound source signals from said output signal information and said separation information; and modifying said mixed signal based upon said separation/resynthesis information.

In addition, the 43rd mode of the present invention, in the above-mentioned mode, is characterized in that the signal control method comprising: generating resynthesis information representing a relation between said mixed signal and said sound source signal from said separation information; generating integrated resynthesis information by integrating said output signal information and said resynthesis information; and generating said separation/resynthesis information by synthesizing said integrated resynthesis information and said separation information.

In addition, the 44th mode of the present invention, in the above-mentioned mode, is characterized in that the signal control method comprising generating said integrated resynthesis information by employing only said resynthesis information.

The 45th mode of the present invention is characterized in that a program for causing an information processing apparatus to execute a separation information calculation process of generating separation information for separating an input signal having sound source signals mixed therein into said sound source signals.

The 45th mode of the present invention is characterized in that a program for causing an information processing apparatus to execute: a resynthesis information calculation process of generating separation information for separating an input signal having sound source signals mixed therein into said sound source signals and resynthesis information representing a relation between said input signal and said sound source signal; and a signal separation process of generating a separated signal by separating said input signal into said sound source signals based upon said separation information.

The 47th mode of the present invention is characterized in that a program for causing an information processing apparatus to execute: a separation information calculation process of generating separation information for separating an input signal having sound source signals mixed therein into said sound source signals; a signal separation process of generating a separated signal by separating said input signal into said sound source signals based upon said separation information; and an encoding process of encoding said separated signal.

The 48th mode of the present invention is characterized in that a program for causing an information processing apparatus into which a mixed signal having sound source signals mixed therein, separation information for separating said mixed signal into said sound source signals, and output signal information for controlling a specific sound source signal are inputted to execute: a separation/resynthesis information generation process of generating separation/resynthesis information for controlling said sound source signals from said output signal information and said separation information; and a signal resynthesis process of modifying said mixed signal based upon said separation/resynthesis information.

The 49th mode of the present invention is characterized in that a program for causing an information processing apparatus into which a down-mixed signal having a mixed signal down-mixed therein, said mixed signal having sound source signals mixed therein, analysis information representing a relation between said down-mixed signal and said mixed signal, separation information for separating said mixed signal into said sound source signals, and output signal information for controlling a specific sound source signal are inputted to execute; a separation/resynthesis information generation process of generating modified separation/resynthesis information for controlling said sound source signals from said output signal information, said analysis information and said separation information; and a signal resynthesis process of modifying said down-mixed signal based upon said modified separation/resynthesis information.

The 50th mode of the present invention is characterized in that a program for causing an information processing apparatus into which a separated signal obtained by separating a mixed signal having sound source signals mixed therein, resynthesis information representing a relation between said mixed signal and said separated signal, and output signal information for controlling a specific sound source signal are inputted to execute: a resynthesis information integration process of generating integrated resynthesis information for controlling said sound source signals from said output signal information and said resynthesis information; and a signal resynthesis process of modifying said separated signal based upon said modified separation/resynthesis information.

The 51st mode of the present invention is characterized in that a program for causing an information processing apparatus into which a down-mixed signal having a separated signal down-mixed therein, said separated signal obtained by separating a mixed signal having sound source signals mixed therein, analysis information representing a relation between said down-mixed signal and said separated signal, resynthesis information representing a relation between said mixed signal and said separated signal, and output signal information for controlling a specific sound source signal are inputted to execute: a resynthesis information modification process of generating modified resynthesis information for controlling said sound source signals from said output signal information, said analysis information, and said resynthesis information; and a signal resynthesis process of modifying said down-mixed signal based upon said modified resynthesis information.

The 52nd mode of the present invention is characterized in that a program for causing an information processing apparatus into which a separated signal obtained by separating a mixed signal having sound source signals mixed therein, and output signal information for controlling a specific sound source signal are inputted to execute a signal resynthesis process of modifying said separated signal based upon said output signal information.

The 53rd mode of the present invention is characterized in that a program for causing an information processing apparatus into which a down-mixed signal having a separated signal down-mixed therein, said separated signal obtained by separating a mixed signal having sound source signals mixed therein, analysis information representing a relation between said down-mixed signal and said separated signal, and output signal information for controlling a specific sound source signal are inputted to execute: a resynthesis information modification process of generating modified resynthesis information for controlling said sound source signals from said output signal information and said analysis information; and a signal resynthesis process of modifying said down-mixed signal based upon said modified resynthesis information.

The 54th mode of the present invention is characterized in that a program for causing an information processing apparatus into which a mixed signal having sound source signals mixed therein, and output signal information for controlling a specific sound source signal are inputted to execute: a separation information calculation process of generating separation information for separating said mixed signal into said sound source signals; a separation/resynthesis information generation process of generating separation/resynthesis information for controlling said sound source signals from said output signal information and said separation information; and a signal resynthesis process of modifying said mixed signal based upon said separation/resynthesis information.

Above, although the present invention has been particularly described with reference to the preferred embodiments and examples thereof, it should be readily apparent to those of ordinary skill in the art that the present invention is not always limited to the above-mentioned embodiment and modes, and changes and modifications in the form and details may be made without departing from the spirit and scope of the invention.

This application is based upon and claims the benefit of priority from Japanese patent application No. 2008-181242, filed on Jul. 11, 2008, the disclosure of which is incorporated herein in its entirety by reference.

### INDUSTRIAL APPLICABILITY

The present invention may be applied to an apparatus that performs signal analysis or signal control. The present invention may also be applied to a program that causes a computer to execute signal analysis or signal control.

### REFERENCE SIGNS LIST

10, 20, 30, 40, 50, 60, and 70 transmission units
11, 21, 31, 41, 51, 61, and 71 receiving units
101 signal separation unit
102 separation information calculation unit
110, 212, 300, 401, 510, and 900 encoding units
120, 310, 520, and 910 decoding units
130, 330, 430, 530, 630, and 920 signal resynthesis units
210, 400, and 600 low-bit rate encoding units
211 down-mixing unit
213 signal analysis unit
220, 410, and 620 low-bit rate decoding units
240, 421, and 621 modification units
320 and 420 separation/resynthesis information generation units
321 resynthesis information conversion unit
322 resynthesis information integration unit
323 synthesis unit
500 resynthesis information calculation unit
501 resynthesis information shaping unit
620 resynthesis information modification unit
1300 and 1301 computers

1-54. (canceled)

55. A signal analysis apparatus, comprising:
a separation information calculator that generates separation information for separating an input signal having sound source signals mixed therein into said sound source signals; and
an encoder that generates encoding information by encoding said input signal and said separation information,
said signal analysis apparatus sending said encoding information.

56. A signal analysis apparatus according to claim 55, wherein said encoder comprises:
a down-mixing unit that generates a down-mixed signal from said input signal;
a signal analysis unit that generates analysis information representing a relation between said input signal and said down-mixed signal; and
a second encoder that generates encoding information by encoding said down-mixed signal, said analysis information, and said separation information.

57. A signal analysis apparatus, comprising:
a resynthesis information calculator that generates separation information for separating an input signal having sound source signals mixed therein into said sound source signals, and resynthesis information representing a relation between said input signal and said sound source signal;
a signal separation unit that generates separated signal by separating said input signal into said sound source signals based upon said separation information and
an encoder that generates encoding information by encoding said separated signal and said resynthesis information, said signal analysis apparatus sending said encoding information.

58. A signal analysis apparatus according to claim 57, wherein said resynthesis information calculator comprises:
a separation information calculator that generates said separation information for separating said input signal into said sound source signals; and
a resynthesis information conversion unit that generates said resynthesis information representing a relation between said input signal and said sound source signal based upon said separation information.

59. A signal analysis apparatus according to claim 57, wherein said resynthesis information calculator comprises:
a separation information calculator that generates said separation information for separating said input signal into said sound source signals;
a resynthesis information conversion unit that generates said resynthesis information representing a relation between said input signal and said sound source signal based upon said separation information; and
a resynthesis information shaping unit that shapes said resynthesis information.

60. A signal analysis apparatus according to claim 57, wherein said encoder comprises:
a down-mixing unit that generates a down-mixed signal from said separated signal;
a signal analysis unit that generates analysis information representing a relation between said input signal and said down-mixed signal from said input signal; and
a second encoder that generates encoding information by encoding said down-mixed signal, said analysis information, and said resynthesis information.

61. A signal analysis apparatus, comprising:
a separation information calculator that generates separation information for separating an input signal having sound source signals mixed therein into said sound source signals;
a signal separation unit that generates a separated signal by separating said input signal into said sound source signals based upon said separation information;
a down-mixing unit that generates a down-mixed signal from said separated signal;
a signal analysis unit that generates analysis information representing a relation between said separated signal and said down-mixed signal from said separated signal; and
an encoder that encodes said down-mixed signal and said analysis information.

62. A signal control apparatus for receiving a bit stream having a mixed signal having sound source signals mixed therein, and separation information for separating said mixed signal into said sound source signals, and output signal information for controlling a specific sound source signal, comprising:
a decoder that decodes said mixed signal and said separated signal from said bit stream;
a separation/resynthesis information generator that generates separation/resynthesis information for controlling said sound source signals from said output signal information and said separation information; and
a signal resynthesis unit that modifies said mixed signal based upon said separation/resynthesis information.

63. A signal control apparatus according to claim 62, wherein said separation/resynthesis information generator comprises:
a resynthesis information conversion unit that generates resynthesis information representing a relation between said mixed signal and said sound source signal from said separation information;
a resynthesis information integration unit that generates integrated resynthesis information by integrating said output signal information and said resynthesis information; and
a synthesis unit that generates said separation/resynthesis information by synthesizing said integrated resynthesis information and said separation information.

64. A signal control apparatus for receiving a bit stream having a down-mixed signal having a mixed signal down-mixed therein, said mixed signal having sound source signals mixed therein, analysis information representing a relation between said down-mixed signal and said mixed signal, and separation information for separating said mixed signal into said sound source signals, and output signal information for controlling a specific sound source signal, comprising:
a decoder that decodes said down-mixed signal, said analysis information, and said separation information from said bit stream;
a separation/resynthesis information generator that generates modified separation/resynthesis information for controlling said sound source signals from said output signal information, said analysis information, and said separation information; and
a signal resynthesis unit that modifies said down-mixed signal based upon said modified separation/resynthesis information.

65. A signal control apparatus according to claim 64, wherein said separation/resynthesis information generator comprises:
a resynthesis information conversion unit that generates resynthesis information representing a relation between said mixed signal and said sound source signal from said separation information;
a resynthesis information integration unit that generates integrated resynthesis information by integrating said output signal information and said resynthesis information;
a synthesis unit that generates separation/resynthesis information by synthesizing said integrated resynthesis information and said separation information; and
a modification unit that generates said modified separation/resynthesis information by modifying said separation/resynthesis information based upon said analysis information.

66. A signal control apparatus for receiving a bit stream having a separated signal obtained by separating a mixed signal having sound source signals mixed therein, and resynthesis information representing a relation between said mixed signal and said separated signal, and output signal information for controlling a specific sound source signal, comprising:
a decoder that decodes said separated signal and said resynthesis information from said bit stream;
a resynthesis information integration unit that generates integrated resynthesis information for controlling said sound source signals from said output signal information and said resynthesis information; and
a signal resynthesis unit that modifies said separated signal based upon said integrated resynthesis information.

67. A signal control apparatus for receiving a bit stream having a down-mixed signal having a separated signal down-mixed therein, said separated signal obtained by separating a mixed signal having sound source signals mixed therein, analysis information representing a relation between said down-mixed signal and said separated signal, and resynthesis information representing a relation between said mixed signal and said separated signal, and output signal information for controlling a specific sound source signal, comprising:
a decoder that decodes said down-mixed signal, said analysis information, and said resynthesis information from said bit stream;
a resynthesis information modification unit that generates modified resynthesis information for controlling said sound source signals from said output signal information, said analysis information, and said resynthesis information; and
a signal resynthesis unit that modifies said down-mixed signal based upon said modified resynthesis information.

68. A signal control apparatus according to claim 67, wherein said resynthesis information modification unit comprises:
a resynthesis information integration unit that generates integrated resynthesis information by integrating said output signal information and said resynthesis information; and
a modification unit that generates said modified resynthesis information by modifying said integrated resynthesis information based upon said analysis information.

69. A signal control apparatus for receiving a bit stream having a separated signal obtained by separating a mixed signal having sound source signals mixed therein, and output signal information for controlling a specific sound source signal, comprising:
a decoder that decodes said separated signal from said bit stream; and
a signal resynthesis unit that modifies said separated signal based upon said output signal information.

70. A signal control apparatus for receiving a bit stream having a down-mixed signal having a separated signal down-mixed therein, said separated signal obtained by separating a mixed signal having sound source signals mixed therein, and analysis information representing a relation between said down-mixed signal and said separated signal, and output signal information for controlling a specific sound source signal, comprising:
a decoder that decodes said down-mixed signal and said analysis information from said bit stream;
a resynthesis information modification unit that generates modified resynthesis information for controlling said sound source signals from said output signal information and said analysis information; and
a signal resynthesis unit that modifies said down-mixed signal based upon said modified resynthesis information.

71. A signal control apparatus for receiving a bit stream having a mixed signal having sound source signals mixed therein, and output signal information for controlling a specific sound source signal, comprising:
a decoder that decodes said mixed signal from said bit stream;
a separation information calculator for generating separation information for separating said mixed signal into said sound source signals;
a separation/resynthesis information generator that generates separation/resynthesis information for controlling said sound source signals from said output signal information and said separation information; and
a signal resynthesis unit that modifies said mixed signal based upon said separation/resynthesis information.

72. A signal control apparatus according to claim 71, wherein said separation/resynthesis information generator comprises:
a resynthesis information conversion unit that generates resynthesis information representing a relation between said mixed signal and said sound source signal from said separation information;
a resynthesis information integration unit that generates integrated resynthesis information by integrating said output signal information and said resynthesis information; and
a synthesis unit that generates said separation/resynthesis information by synthesizing said integrated resynthesis information and said separation information.

73. A signal control apparatus according to claim 63, wherein said signal control apparatus generates said integrated resynthesis information by employing only said resynthesis information.

74. A signal analysis method, comprising:
generating separation information for separating an input signal having sound source signals mixed therein into said sound source signals; and
generating encoding information by encoding said input signal and said separation information; and
sending said encoding information.

75. A signal analysis method according to claim 74, wherein said encoding comprises:
generating a down-mixed signal from said input signal;
generating analysis information representing a relation between said input signal and said down-mixed signal; and
generating encoding information by encoding said down-mixed signal, said analysis information, and said separation information.

76. A signal analysis method, comprising:
generating separation information for separating an input signal having sound source signals mixed therein into said sound source signals, and resynthesis information representing a relation between said input signal and said sound source signal;
generating a separated signal by separating said input signal into said sound source signals based upon said separation information;
generating encoding information by encoding said separated signal and said resynthesis information; and
sending said encoding information.

77. A signal analysis method according to claim 76, comprising:
generating said separation information for separating said input signal into said sound source signals; and
generating said resynthesis information based upon said separation information.

78. A signal analysis method according to claim 76, comprising:
generating said separation information for separating said input signal into said sound source signals;
generating said resynthesis information based upon said separation information; and
shaping said resynthesis information.

79. A signal analysis method according to claim 76, comprises:
generating a down-mixed signal from said separated signal;
generating analysis information representing a relation between said input signal and said down-mixed signal from said input signal; and
generating said encoding information by encoding said down-mixed signal, said analysis information, and said resynthesis information.

80. A signal analysis method, comprising:
generating separation information for separating an input signal having sound source signals mixed therein into said sound source signals;
generating a separated signal by separating said input signal into said sound source signals based upon said separation information;
generating a down-mixed signal from said separated signal;
generating analysis information representing a relation between said separated signal and said down-mixed signal from said separated signal; and
encoding said down-mixed signal and said analysis information.

81. A signal control method comprising:
receiving a bit stream having a mixed signal having sound source signals mixed therein, and separation information for separating said mixed signal into said sound source signals, and output signal information for controlling a specific sound source signal;
decoding said mixed signal and said separation information from said bit stream;
generating separation/resynthesis information for controlling said sound source signals from said output signal information and said separation information; and
modifying said mixed signal based upon said separation/resynthesis information.

82. A signal control method according to claim 81, comprising:
generating resynthesis information representing a relation between said mixed signal and said sound source signal from said separation information;
generating integrated resynthesis information by integrating said output signal information and said resynthesis information; and
generating said separation/resynthesis information by synthesizing said integrated resynthesis information and said separation information.

83. A signal control method, comprising:
receiving a bit stream having a down-mixed signal having a mixed signal down-mixed therein, said mixed signal having sound source signals mixed therein, analysis information representing a relation between said down-mixed signal and said mixed signal, and separation information for separating said mixed signal into said sound source signals, and output signal information for controlling a specific sound source signal;
decoding said down-mixed signal, said analysis information, and said separation information from said bit stream;
generating modified separation/resynthesis information for controlling said sound source signals from said output signal information, said analysis information and said separation information; and
modifying said down-mixed signal based upon said modified separation/resynthesis information.

84. A signal control method according to claim 83, comprising:
generating resynthesis information representing a relation between said mixed signal and said sound source signal from said separation information;
generating integrated resynthesis information by integrating said output signal information and said resynthesis information;
generating separation/resynthesis information by synthesizing said integrated resynthesis information and said separation information; and
generating said modified separation/resynthesis information by modifying said separation/resynthesis information based upon said analysis information.

85. A signal control method, comprising:
receiving a bit stream having a separated signal obtained by separating a mixed signal having sound source signals mixed therein, and resynthesis information representing a relation between said mixed signal and said separated signal, and output signal information for controlling a specific sound source signal;
decoding said separated signal and said resynthesis information from said bit stream;
generating integrated resynthesis information for controlling said sound source signals from said output signal information and said resynthesis information; and
modifying said separated signal based upon said integrated resynthesis information.

86. A signal control method, comprising
receiving a bit stream having a down-mixed signal having a separated signal down-mixed therein, said separated signal obtained by separating a mixed signal having sound source signals mixed therein, analysis information representing a relation between said down-mixed signal and said separated signal, and resynthesis information representing a relation between said mixed signal and said separated signal, and output signal information for controlling a specific sound source signal;
decoding said down-mixed signal, said analysis information, and said resynthesis information from said bit stream;
generating modified resynthesis information for controlling said sound source signals from said output signal information, said analysis information, and said resynthesis information; and
modifying said down-mixed signal based upon said modified resynthesis information.

87. A signal control method according to claim 86, comprising:
generating integrated resynthesis information by integrating said output signal information and said resynthesis information; and
generating said modified resynthesis information by modifying said integrated resynthesis information based upon said analysis information.

88. A signal control method, comprising:
receiving a bit stream having a separated signal obtained by separating a mixed signal having sound source signals mixed therein, and output signal information for controlling a specific sound source signal;
decoding said separated signal from said bit stream; and
modifying said separated signal based upon said output signal information.

89. A signal control method, comprising:
receiving a bit stream having a down-mixed signal having a separated signal down-mixed therein, said separated signal obtained by separating a mixed signal having sound source signals mixed therein, and analysis information representing a relation between said down-mixed signal and said separated signal, and output signal information for controlling a specific sound source signal;
decoding said down-mixed signal and said analysis information from said bit stream;
generating modified resynthesis information for controlling said sound source signals from said output signal information and said analysis information; and
modifying said down-mixed signal based upon said modified resynthesis information.

90. A signal control method, comprising:
receiving a bit stream having a mixed signal having sound source signals mixed therein, and output signal information for controlling a specific sound source signal;
decoding said mixed signal from said bit stream;
generating separation information for separating said mixed signal into said sound source signals;
generating separation/resynthesis information for controlling said sound source signals from said output signal information and said separation information; and
modifying said mixed signal based upon said separation/resynthesis information.

91. A signal control method according to claim 90, comprising:
generating resynthesis information representing a relation between said mixed signal and said sound source signal from said separation information;
generating integrated resynthesis information by integrating said output signal information and said resynthesis information; and
generating said separation/resynthesis information by synthesizing said integrated resynthesis information and said separation information.

92. A signal control method according to claim 82, comprising generating said integrated resynthesis information by employing only said resynthesis information.

93. A non-transitory computer readable storage medium storing a program for causing an information processing apparatus to execute:
a separation information calculation process of generating separation information for separating an input signal having sound source signals mixed therein into said sound source signals; and
an encoding process of generating encoding information by encoding said input signal and said separation information.

94. A non-transitory computer readable storage medium storing a program for causing an information processing apparatus to execute:
a resynthesis information calculation process of generating separation information for separating an input signal having sound source signals mixed therein into said sound source signals and resynthesis information representing a relation between said input signal and said sound source signal;
a signal separation process of generating a separated signal by separating said input signal into said sound source signals based upon said separation information; and
an encoding process of generating encoding information by encoding said separated signal and said resynthesis information.

95. A non-transitory computer readable storage medium storing a program for causing an information processing apparatus to execute:
a separation information calculation process of generating separation information for separating an input signal having sound source signals mixed therein into said sound source signals;
a signal separation process of generating a separated signal by separating said input signal into said sound source signals based upon said separation information;
a down-mixing process of generating a down-mixed signal from said separated signal;
a signal analysis process of generating analysis information representing a relation between said separated signal and said down-mixed signal from said separated signal; and
an encoding process of encoding said down-mixed signal and said analysis information.

96. A non-transitory computer readable storage medium storing a program for causing an information processing apparatus into which a bit stream having a mixed signal having sound source signals mixed therein, and separation information for separating said mixed signal into said sound source signals, and output signal information for controlling a specific sound source signal are inputted to execute:
a decoding process of decoding said mixed signal and said separation information from said bit stream;
a separation/resynthesis information generation process of generating separation/resynthesis information for controlling said sound source signals from said output signal information and said separation information; and
a signal resynthesis process of modifying said mixed signal based upon said separation/resynthesis information.

97. A non-transitory computer readable storage medium storing a program for causing an information processing apparatus into which a bit stream having a down-mixed signal having a mixed signal down-mixed therein, said mixed signal having sound source signals mixed therein, analysis information representing a relation between said down-mixed signal and said mixed signal, and separation information for separating said mixed signal into said sound source signals, and output signal information for controlling a specific sound source signal are inputted to execute;
a decoding process of decoding said down-mixed signal, said analysis information, and said separation information from said bit stream;
a separation/resynthesis information generation process of generating modified separation/resynthesis information for controlling said sound source signals from said output signal information, said analysis information and said separation information; and
a signal resynthesis process of modifying said down-mixed signal based upon said modified separation/resynthesis information.

98. A non-transitory computer readable storage medium storing a program for causing an information processing apparatus into which a bit stream having a separated signal obtained by separating a mixed signal having sound source signals mixed therein, and resynthesis information representing a relation between said mixed signal and said separated signal, and output signal information for controlling a specific sound source signal are inputted to execute:
a decoding process of decoding said separated signal and said resynthesis information from said bit stream;
a resynthesis information integration process of generating integrated resynthesis information for controlling said sound source signals from said output signal information and said resynthesis information; and
a signal resynthesis process of modifying said separated signal based upon said integrated resynthesis information.

99. A non-transitory computer readable storage medium storing a program for causing an information processing apparatus into which a bit stream having a down-mixed signal having a separated signal down-mixed therein, said separated signal obtained by separating a mixed signal having sound source signals mixed therein, analysis information representing a relation between said down-mixed signal and said separated signal, and resynthesis information representing a relation between said mixed signal and said separated signal, and output signal information for controlling a specific sound source signal are inputted to execute:
a decoding process of decoding said down-mixed signal, said analysis information, and said resynthesis information from said bit stream;
a resynthesis information modification process of generating modified resynthesis information for controlling said sound source signals from said output signal information, said analysis information, and said resynthesis information; and
a signal resynthesis process of modifying said down-mixed signal based upon said modified resynthesis information.

100. A non-transitory computer readable storage medium storing a program for causing an information processing apparatus into which a bit stream having a separated signal obtained by separating a mixed signal having sound source signals mixed therein, and output signal information for controlling a specific sound source signal are inputted to execute:
a decoding process of decoding said separated signal from said bit stream; and
a signal resynthesis process of modifying said separated signal based upon said output signal information.

101. A non-transitory computer readable storage medium storing a program for causing an information processing apparatus into which a bit stream having a down-mixed signal having a separated signal down-mixed therein, said separated signal obtained by separating a mixed signal having sound source signals mixed therein, and analysis information representing a relation between said down-mixed signal and said separated signal, and output signal information for controlling a specific sound source signal are inputted to execute:
a decoding process of decoding said down-mixed signal and said analysis information from said bit stream;
a resynthesis information modification process of generating modified resynthesis information for controlling said sound source signals from said output signal information and said analysis information; and
a signal resynthesis process of modifying said down-mixed signal based upon said modified resynthesis information.

102. A non-transitory computer readable storage medium storing a program for causing an information processing apparatus into which a bit stream having a mixed signal having sound source signals mixed therein, and output signal information for controlling a specific sound source signal are inputted to execute:
a decoding process of decoding said mixed signal from said bit stream;
a separation information calculation process of generating separation information for separating said mixed signal into said sound source signals;
a separation/resynthesis information generation process of generating separation/resynthesis information for controlling said sound source signals from said output signal information and said separation information; and
a signal resynthesis process of modifying said mixed signal based upon said separation/resynthesis information.

103. A signal control apparatus according to claim 65, said signal control apparatus generating said integrated resynthesis information by employing only said resynthesis information.

104. A signal control apparatus according to claim 66, said signal control apparatus generating said integrated resynthesis information by employing only said resynthesis information.

105. A signal control apparatus according to claim 68, said signal control apparatus generating said integrated resynthesis information by employing only said resynthesis information.

106. A signal control apparatus according to claim 72, said signal control apparatus generating said integrated resynthesis information by employing only said resynthesis information.

107. A signal control apparatus according to claim 84, said signal control apparatus generating said integrated resynthesis information by employing only said resynthesis information.

108. A signal control apparatus according to claim 85, said signal control apparatus generating said integrated resynthesis information by employing only said resynthesis information.

109. A signal control apparatus according to claim 87, said signal control apparatus generating said integrated resynthesis information by employing only said resynthesis information.

110. A signal control apparatus according to claim 91, said signal control apparatus generating said integrated resynthesis information by employing only said resynthesis information.

111. A signal analysis method according to claim 77, comprises:
generating a down-mixed signal from said separated signal;
generating analysis information representing a relation between said input signal and said down-mixed signal from said input signal; and
generating said encoding information by encoding said down-mixed signal, said analysis information, and said resynthesis information.

112. A signal analysis method according to claim 78, comprises:
generating a down-mixed signal from said separated signal;
generating analysis information representing a relation between said input signal and said down-mixed signal from said input signal; and
generating said encoding information by encoding said down-mixed signal, said analysis information, and said resynthesis information.
